(19) United States
(12) Patent Application Publication
(10) Pub. No.: US 2026/0082179 A1
(43) Pub. Date: Mar. 19, 2026

(54) TRACKER DEVICE SENSING CONFIGURATION BASED ON NEIGHBOR CONTEXT INFORMATION AND PASSIVE SENSOR DATA

(71) Applicant: QUALCOMM Incorporated, San Diego, CA (US)

(72) Inventors: Mehul SOMAN, San Jose, CA (US); Shashank NARAYANAN, Tracy, CA (US); Ashwin GOYAL, Milpitas, CA (US); Rashmi KULKARNI, Redwood City, CA (US)

(21) Appl. No.: 18/886,800

(22) Filed: Sep. 16, 2024

(51) Int. Cl. H04W 4/029; H04W 4/38

(52) U.S. Cl. CPC H04W 4/029; H04W 4/38

(57) ABSTRACT

Systems and techniques are provided for sensing and device tracking. For example, a process can include obtaining first sensor data from a plurality of sensors configured with a first sensor operation mode and included in a tracker device of a plurality of tracker devices. Neighbor context information can be determined for the tracker device based on passive sensing data included in the first sensor data, and can be indicative of a placement of the tracker device relative to one or more additional tracker devices included in the plurality of tracker devices. An updated sensor operation mode can be determined for the tracker device in response to one or more changes in the neighbor context information, the updated sensor operation mode different from the first sensor operation mode. Second sensor data can be obtained from the plurality of sensors based on configuring the tracker device with the updated sensor operation mode.

### FIELD

The present disclosure generally relates to sensing and device tracking. For example, aspects of the present disclosure relate to sensor mode configurations for virtual groups of tracker devices each including one or more passive sensors for determining device and neighbor context information.

### BACKGROUND

Short range wireless communication enables wireless communication over relatively short distances (e.g., within thirty meters). For example, Radio Frequency Identification (RFID) systems can be used to perform short range wireless communication based on the wireless transfer of data between a reader (e.g., RFID reader device) and a tag or transponder (e.g., RFID tag). RFID systems can be used for identification, tracking, data storage, etc. For example, RFID systems can be used to identify and/or track various items, such as warehouse boxes or consumer products.

An RFID tag may be attached to an item to be tracked and may include data storage and an antenna. The data storage stores information corresponding to the associated item, such as a product name, a serial number, product information, a manufacturer, etc. The antenna enables the RFID tag to be read by an RFID reader, which transmits an interrogation signal to one or more RFID tags within communication range. RFID tags can be passive, active, semi-passive or semi-active. Passive RFID tags utilize the interrogation signal from an RFID reader to power a transmission by or from the RFID tag. Active, semi-passive and semi-active RFID tags can include a power source or battery, which can be used to power a transmission by or from the RFID tag.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for sensing and device tracking. According to at least one illustrative example, a method is provided, the method comprising: obtaining first sensor data from a plurality of sensors included in a tracker device configured with a first sensor operation mode, the tracker device included in a plurality of tracker devices; determining neighbor context information for the tracker device, the neighbor context information indicative of a placement of the tracker device relative to one or more additional tracker devices included in the plurality of tracker devices, wherein the neighbor context information is determined based on passive sensing data included in the first sensor data; determining an updated sensor operation mode for the tracker device in response to one or more changes in the neighbor context information for the tracker device, wherein the updated sensor operation mode is different from the first sensor operation mode; and obtaining second sensor data from the plurality of sensors configured with the updated sensor operation mode.

In another example, an apparatus for sensing and device tracking is provided. The apparatus includes at least one memory and at least one processor coupled to the at least one memory and configured to: obtain first sensor data from a plurality of sensors included in a tracker device configured with a first sensor operation mode, the tracker device included in a plurality of tracker devices; determine neighbor context information for the tracker device, the neighbor context information indicative of a placement of the tracker device relative to one or more additional tracker devices included in the plurality of tracker devices, wherein the neighbor context information is determined based on passive sensing data included in the first sensor data; determine an updated sensor operation mode for the tracker device in response to one or more changes in the neighbor context information for the tracker device, wherein the updated sensor operation mode is different from the first sensor operation mode; and obtain second sensor data from the plurality of sensors configured with the updated sensor operation mode.

In another example, a non-transitory computer-readable medium is provided that includes instructions that, when executed by at least one processor, cause the at least one processor to: obtain first sensor data from a plurality of sensors included in a tracker device configured with a first sensor operation mode, the tracker device included in a plurality of tracker devices; determine neighbor context information for the tracker device, the neighbor context information indicative of a placement of the tracker device relative to one or more additional tracker devices included in the plurality of tracker devices, wherein the neighbor context information is determined based on passive sensing data included in the first sensor data; determine an updated sensor operation mode for the tracker device in response to one or more changes in the neighbor context information for the tracker device, wherein the updated sensor operation mode is different from the first sensor operation mode; and obtain second sensor data from the plurality of sensors configured with the updated sensor operation mode.

In another example, an apparatus is provided. The apparatus includes: means for obtaining first sensor data from a plurality of sensors included in a tracker device configured with a first sensor operation mode, the tracker device included in a plurality of tracker devices; means for determining neighbor context information for the tracker device, the neighbor context information indicative of a placement of the tracker device relative to one or more additional tracker devices included in the plurality of tracker devices, wherein the neighbor context information is determined based on passive sensing data included in the first sensor data; means for determining an updated sensor operation mode for the tracker device in response to one or more changes in the neighbor context information for the tracker device, wherein the updated sensor operation mode is different from the first sensor operation mode; and means for obtaining second sensor data from the plurality of sensors configured with the updated sensor operation mode.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating example components of a tracker device, in accordance with some examples;

FIG. 2 is a diagram illustrating an example of a radio frequency identification (RFID) system that may be used to implement one or more tracker devices, in accordance with some examples;

FIG. 3A is a diagram illustrating a first example of an adaptive context detection (ACD) engine associated with a tracker device, in accordance with some examples;

FIG. 3B is a diagram illustrating a second example of an ACD engine associated with a tracker device, in accordance with some examples;

FIG. 4 is a diagram illustrating an example state machine flow corresponding to the ACD engine and hardware context information associated with the tracker device system of FIG. 3A, in accordance with some examples;

FIG. 5 is a diagram illustrating an example state machine flow corresponding to the ACD engine and hardware context information associated with the tracker device system of FIG. 3B, in accordance with some examples;

FIG. 6 is a diagram illustrating an example of ACD state information and ACD state transitions for a tracker device included in a virtual group of a plurality of tracker devices, in accordance with some examples;

FIGS. 7A-7C illustrate examples of respective ACD state information and ACD state transitions for a virtual group of tracker devices associated with packages, in accordance with some examples;

FIGS. 8A-8B illustrate examples of respective ACD state information and ACD state transitions for a virtual group of tracker devices comprising smart labels attached to envelopes or mail pieces, in accordance with some examples;

FIG. 9 is a diagram illustrating an example of inferred sensor data determined based on group sensor data information corresponding to a virtual group of a plurality of tracker devices, in accordance with some examples;

FIG. 10 is a flowchart diagram illustrating an example of a process for sensing and device tracking, in accordance with some examples; and

FIG. 11 is a block diagram illustrating an example of a computing system, which may be employed by the disclosed systems and techniques, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Various tracker devices can be used for providing sensing and/or tracking for attached objects. For example, one or more tracker devices (e.g., also referred to as “trackers”) can be attached to an object such as an envelope, mail piece, package, container, pallet, etc., and used to provide sensing and/or tracking for the attached object. In some examples, the sensor data obtained using the one or more trackers attached to the object can be used to determine tracking information of the object during transit (e.g., as the object is shipped, moved between locations, stored in a warehouse, etc.).

In some examples, a tracker can be implemented as a “smart envelope” or “smart label,” which can be used for tracking mail envelopes, for remote sensor nodes for environmental monitoring, etc. A smart envelope can integrate or combine a tracker device with an envelope configured to receive a mail item, documents, small objects, etc. A smart label can integrate or combine a tracker device with label that may be attached or affixed to an object that is to be tracked. For example, a smart label can be provided as an adhesive label that can be attached to an object to be tracked. In some cases, the adhesive label can be a printed adhesive label, where some or all of the tracker device electronic and/or circuitry components are printed on or within the substrate of the adhesive label.

Smart envelopes, smart labels, and/or other tracker devices may be implemented as relatively small, low-cost, and ultra-low power devices that can operate in an always on power configuration to sense, track, and/or monitor for configured events. The configured monitored events can be intermittent and/or periodic events, which can correspond to the always on power configuration that may be used for the smart label or other tracker device. In some examples, the small form factor, low-cost, and low-power requirements for smart label and other tracker device implementations can correspond to resource-constrained or resource-limited hardware designs or hardware implements of the smart label or tracker device. For example, the smart label or tracker device may utilize processing hardware (e.g., microcontroller units (MCUs), etc.) with relatively limited capabilities. In addition to relatively limited compute capabilities associated with hardware implementations for smart labels or other tracker devices, the onboard or included sensors provided in the smart label or tracker device hardware implementation may additionally be limited in quantity, capabilities, complexity, sensor polling rate, range, power mode configuration, etc.

In some examples, a smart label or other tracker device can include one or more embedded sensors (e.g., physical sensors) that can be used to obtain sensor data corresponding to the surrounding environment. For example, tracker device may include a processor or MCU and one or more physical sensors such as an accelerometer, an ambient light sensor (ALS), a proximity sensor, a humidity sensor, a barometer or pressure sensor, an inertial measurement sensor (IMS), an inertial measurement unit (IMU), a gyroscopic or rotation sensor, etc. In some cases, a smart envelope or smart label may include the one or more embedded, physical sensors to provide monitoring data to ensure that specified environmental conditions and/or handling conditions are met or maintained within a configured range during transit of the smart envelope or smart label. In some examples, the one or more sensors included in a tracker device can be passive sensors, configured to perform passive sensing based on receiving or detecting a signal or other sensed quantity or sensed characteristic present within the surrounding environment. For example, the passive sensors and passive sensing performed by a tracker device can be implemented without active transmission, interrogation, or broadcast of a wireless signal (e.g., a sensing signal, interrogation signal, etc.) by the tracker device or the sensors included in the tracker device.

General smart device architectures (e.g., including Internet-of-Things (IoT) device architectures, etc.) may also utilize physical sensors, combined with a relatively low-power MCU or digital signal processor (DSP) to analyze collected sensor data, and cloud or local area network (LAN) connectivity to share and manage information. However, these general smart device architecture often require significantly more power than the limited power that is available on a smart envelope or smart label device. For example, physical sensors (e.g., such as accelerometers, ALS sensors, proximity sensors, humidity sensors, pressure or barometric sensors, etc.) may be unable to optimize or balance the tradeoff between the sensor power mode configuration versus the sample rate of data obtained using the sensor. Optimizing the sensor power mode configuration versus the sensor sample rate tradeoff can be beneficial for ensuring accurate detection(s) of configured events while maintaining the physical sensor in an always-on mode.

The optimization and/or configuration of sensor power mode and sensor sample rate is, in many examples, performed in the MCU or DSP. To implement a low-power MCU or DSP, the MCU or DSP can be configured with a duty cycle within which the MCU or DSP wakes from sleep to perform data analysis to detect the sensor context, and subsequently generate or perform any actions based on the detected sensor context before returning to the sleep mode (e.g., before going back to sleep). The power consumption associated with these MCU or DSP implementations, even with duty cycling, can be prohibitive for use in smart envelopes or smart label devices (e.g., the power consumption associate with these MCU or DSP implementations can quickly exceed the limited power available to a smart envelope or smart label device).

General smart device architectures can perform wireless RF communications using various standards and/or communication techniques and protocols, including Bluetooth Low Energy (BLE), IPv6 over Low-Power Wireless Personal Area Networks (6LoWPAN), Ultra-Wideband (UWB), WiFi, etc. These RF communication techniques can utilize relatively large amounts of power for processing the corresponding standard frame design(s) for the reception and transmission of data. Additional RF techniques such as location and/or position determination may additionally utilize relatively large amounts of power to perform corresponding signal processing, transmission, and/or reception operations. These RF communications and RF-based techniques can additionally be associated with a non-trivial power overhead to manage the signal path calculations.

There is a need for systems and techniques that can be used to more efficiently provide smart envelope and smart label device (e.g., tracker device) implementations that can determine context information and perform group management for a plurality (or subset thereof) of tracker devices that are associated with the same virtual group or cohort. There is a further need for systems and techniques that can be used to provide virtual group management and group context information determination for the plurality of tracker devices of the virtual group or cohort, while minimizing power consumption and meeting performance objectives configured for associated with one or more of the tracker devices included within the virtual group or cohort.

Systems, apparatuses, processes (also referred to as methods), and computer-readable media (collectively referred to as “systems and techniques”) are described herein that can be used to provide group management and context information for a virtual group or cohort of a plurality of tracker devices (e.g., smart envelopes, smart labels, etc.) that are configured to perform passive sensing. For example, the systems and techniques can be used to determine device context information and/or neighbor context information for various tracker devices of a plurality of tracker devices associated with a virtual group or cohort. The virtual group or cohort of tracker devices can be determined without wireless communications (or wired communications) between the respective tracker devices included in the plurality of tracker devices of the virtual group or cohort. For example, the device context information and neighbor context information can be determined for each respective tracker device, based on each respective tracker device obtaining passive sensor information. Each respective tracker device can periodically or intermittently use the passive sensor information to determine a device context information (e.g., corresponding to the respective tracker device itself) and to infer a neighbor context information (e.g., corresponding to relative placement information between the respective tracker device and additional, neighboring tracker devices of the virtual group).

The neighbor context information can be determined using the passive sensor information obtained by one or more sensors included in the respective tracker device. The neighbor context information may additionally be determined or inferred without performing communications between the respective tracker device and any additional tracker devices included in the plurality of tracker devices of the virtual group or cohort. In some aspects, the respective tracker device can infer the presence of one or more neighboring tracker devices, without determining a unique identifier or other identifying information of the particular tracking device of the virtual group that is currently placed as a neighboring tracker device of the respective tracker device.

In one illustrative example, the systems and techniques described herein can be used to determine or infer context information for a tracker device, based on sensor information obtained using one or more sensors included in the tracker device. Using the context information, the tracker device can configure a power mode and/or a sensor operation mode that minimizes the power consumption of the tracker device while also meeting configured performance thresholds or objectives set for the tracker device. For example, the tracker device can be configured to obtain first sensor data from a plurality of sensors of the tracker device using a first sensor operation mode. The tracker device can determine neighbor context information based on the first sensor data obtained using the first sensor operation mode. The neighbor context information can be indicative of a placement of the tracker device relative to one or more additional tracker devices included in the same virtual group or cohort of tracker devices. As noted above, the neighbor context information can be determined based on passive sensing data, where the passive sensing data is included in the first sensor data obtained using the first sensor operation mode. Based on detecting or identifying one or more changes in the neighbor context information for the tracker device, the tracker device can determine an updated sensor operation mode that is different from the first sensor operation mode.

For example, the updated sensor operation mode can cause the tracker device to stop collection of respective sensor information from one or more sensors included in the plurality of sensors. The updated sensor operation mode may additionally, or alternatively, correspond to a reduction in a sensor data collection frequency by the tracker device. The updated sensor operation mode to stop and/or reduce collection of respective sensor information can be in response to a change in the neighbor context information, where the change is indicative of a placement of one or more additional tracker devices on top of the tracker device.

In another example, the updated sensor operation mode can cause the tracker device to begin collection of respective sensor information from one or more additional sensors of the tracker device, wherein the one or more additional sensors are not included in the plurality of sensors used for collection of the first sensor data. The updated sensor operation mode can additionally, or alternatively, correspond to an increase in a sensor data collection frequency by the tracker device. The updated sensor operation mode to begin collection of respective sensor information can be in response to a change in the neighbor context information indicative of a removal of one or more additional tracker devices from a placement on top of the tracker device.

In some aspects, the context information associated with the tracker device can be determined by the tracker device (e.g., determined by a processor, MCU, DSP, etc., included in the tracker device). In some aspects, the context information can be indicative of a context of the environment in which the tracker device is placed or located. In some cases, the context information can be indicative of or otherwise correspond to a placement of the tracker device relative to one or more additional tracker device (or other similar tracker devices, including smart envelopes and smart labels, etc.).

Using the context information, the tracker device can configure one or more operating parameters or operating modes for the one or more sensors included in the tracker device. In some aspects, the context information can be used to configure the sensor operation and/or power mode(s) of the tracker device, without the need for communications between the smart envelope and additional tracker devices that are nearby. For example, based on the context information determined or inferred from the sensor data obtained by the tracker device, the tracker device can configure its sensors to perform (or not perform) data collection, can configure its sensors to perform data collection at greater or lesser frequency or periodicity, etc.

In some cases, the systems and techniques can be implemented at the hardware-level (e.g., hardened into the chip-level or silicon-level implementation of the tracker device or smart label device, etc.), for example as an adaptive context detector (ACD) that is used to minimize the power consumption of the smart envelope or smart label (e.g., tracker device) that includes the ACD. In some cases, the ACD can be configured to adjust or change one or more physical sensor attributes based on determining the context of the device (e.g., the tracker device including the ACD), without waking the entire DSP or MCU from a sleep state or sleep mode.

In some examples, the context information corresponding to the environment around the tracker device can be used to determine whether the tracker device is included in a group of tracker devices (e.g., the virtual group or cohort of tracker devices). In some cases, the virtual group or cohort of tracker devices can correspond to a plurality of tracker devices that are within a threshold distance from one another and/or a plurality of tracker devices that move together. The tracker device can determine or adjust the operational configuration of the included sensors (e.g., of the tracker device) without performing communications with nearby tracker devices that may be included in the same group (or that are otherwise determined to be present based on the context information for the device).

Further aspects of the systems and techniques will be described with reference to the figures.

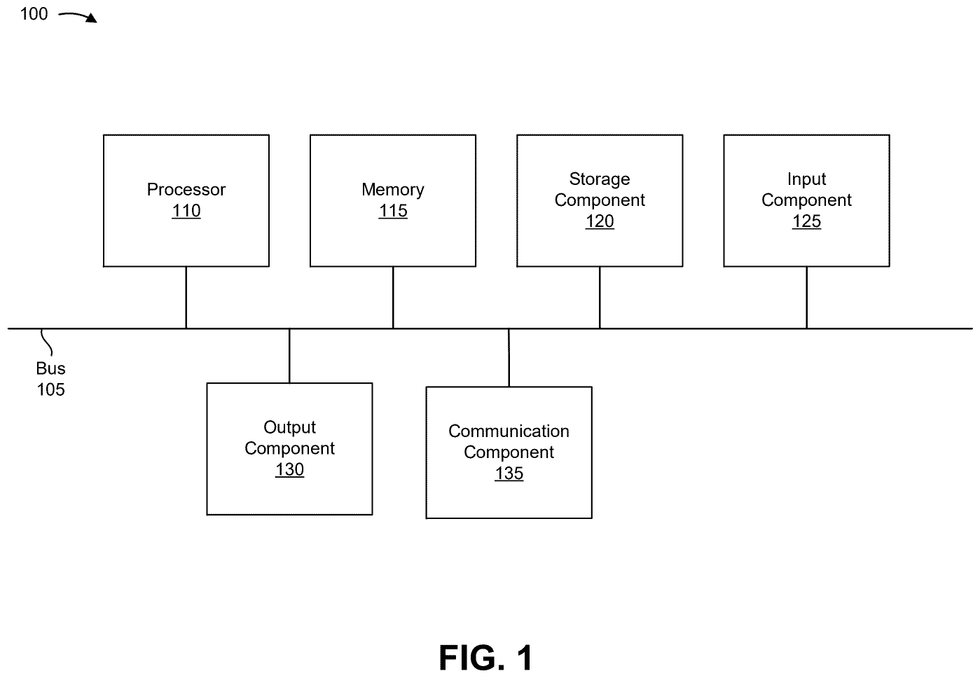

FIG. 1 is a diagram illustrating example components of a device 100, in accordance with the present disclosure. In some aspects, the device 100 can comprise, or be used to implement, a tracker device. As shown in FIG. 1, device 100 may include a bus 105, a processor 110, a memory 115, a storage component 120, an input component 125, an output component 130, and/or a communication component 135.

Bus 105 may include a component that permits communication among the components of device 100. Processor 110 may be implemented in hardware, firmware, or a combination of hardware and software. Processor 110 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 110 may include one or more processors capable of being programmed to perform a function. Memory 115 may include a random access memory (RAM), a read only memory (ROM), and/or another type of dynamic or static storage device (e.g., a flash memory, a magnetic memory, and/or an optical memory) that stores information and/or instructions for use by processor 110.

Storage component 120 can store information and/or software related to the operation and use of device 100. For example, storage component 120 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 125 may include a component that permits device 100 to receive information, such as via user input (e.g., a touch screen display, a keyboard, a keypad, a mouse, a button, a switch, and/or a microphone). Additionally, or alternatively, input component 125 may include a component for determining a position or a location of device 100 (e.g., a global positioning system (GPS) component or a global navigation satellite system (GNSS) component) and/or a sensor for sensing information (e.g., an accelerometer, a gyroscope, an actuator, or another type of position or environment sensor). Output component 130 can include a component that provides output information from device 100 (e.g., a display, a speaker, a haptic feedback component, and/or an audio or visual indicator).

Communication component 135 may include one or more transceiver-like components (e.g., a transceiver and/or a separate receiver and transmitter) that enables device 100 to communicate with other devices, such as via a wired connection, a wireless connection, or a combination of wired and wireless connections. Communication component 135 may permit device 100 to receive information from another device and/or provide information to another device. For example, communication component 135 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

Communication component 135 may include one or more antennas for receiving wireless radio frequency (RF) signals transmitted from one or more other devices, cloud networks, and/or the like. The antenna may be a single antenna or an antenna array (e.g., antenna phased array) that can facilitate simultaneous transmit and receive functionality. The antenna may be an omnidirectional antenna such that signals can be received from and transmitted in all directions. The wireless signals may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network.

The one or more transceiver-like components (e.g., a wireless transceiver) of the communication component 135 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals into a baseband or intermediate frequency and can convert the RF signals to the digital domain.

In some cases, a CODEC may be implemented (e.g., by the processor 110) to encode and/or decode data transmitted and/or received using the one or more wireless transceivers. In some cases, encryption-decryption may be implemented (e.g., by the processor 110) to encrypt and/or decrypt data (e.g., according to the Advanced Encryption Standard (AES) and/or Data Encryption Standard (DES) standard) transmitted and/or received by the one or more wireless transceivers. In some aspects, device 100 may represent an ESL. The ESL may include a battery in addition to the aforementioned components. In some aspects, the output component 130 of the ESL may be an electronic paper (e-paper) display or a liquid crystal display (LCD).

Device 100 may perform one or more processes described herein. Device 100 may perform these processes based on processor 110 executing software instructions stored by a non-transitory computer-readable medium, such as memory 115 and/or storage component 120. A computer-readable medium is defined herein as a non-transitory memory device. A memory device includes memory space within a single physical storage device or memory space spread across multiple physical storage devices.

Software instructions may be read into memory 115 and/or storage component 120 from another computer-readable medium or from another device via communication component 135. When executed, software instructions stored in memory 115 and/or storage component 120 may cause processor 110 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The number and arrangement of components shown in FIG. 1 are provided as an example. In practice, device 100 may include additional components, fewer components, different components, or differently arranged components than those shown in FIG. 1. Additionally, or alternatively, a set of components (e.g., one or more components) of device 100 may perform one or more functions described as being performed by another set of components of device 100.

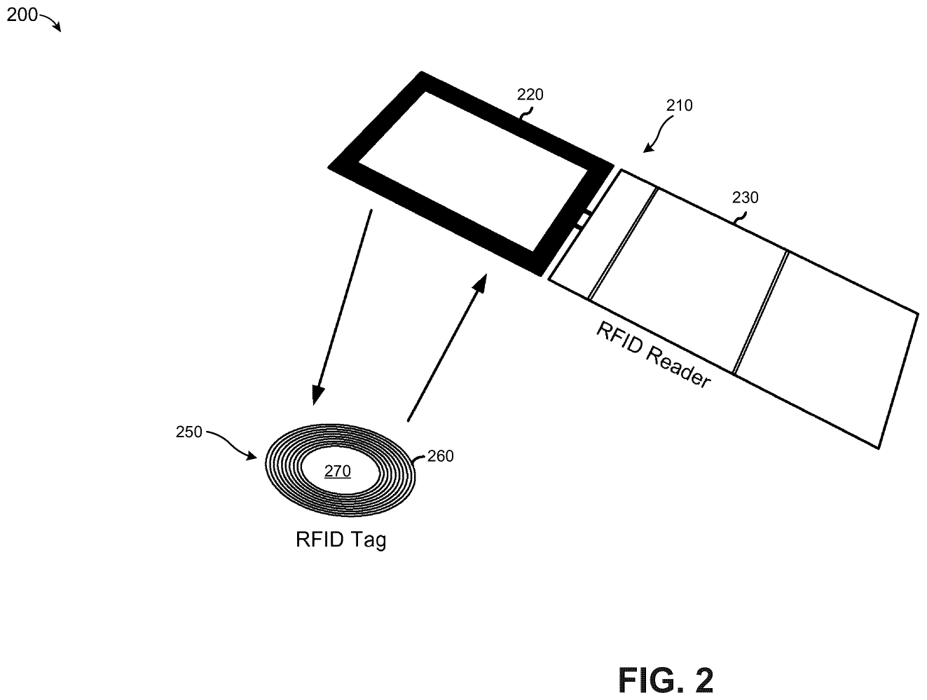

FIG. 2 is a diagram illustrating an example of a radio frequency identification (RFID) system that can be used to implement a tracker device, in accordance with some examples. As noted previously, in some cases a tracker device may be implemented as a passive sensing and tracking device that does not perform wireless (e.g., RF) communications with other tracker devices. In some cases, a tracker device can be wireless communication-capable, but is configured to not use or perform wireless communications during transit and/or with other tracker device. The wireless communication-capable tracker device can be configured to perform wireless communications with a separate reader device, which for example may be used to read and/or write information from and/or to (respectively) the wireless communication-capable tracker device.

In other examples, the tracker device can be implemented as a passive sensing and tracking device that does not include wireless communications capabilities (e.g., does not include wireless communication hardware components, antennas, transceivers, etc.). In such examples, the tracker device may be referred to as a non-wireless communication-capable tracker device, and may communicate with a separate reader device using wired communications or other data transfer techniques, etc.

In some aspects, a tracker device that is wireless communication-capable may be configured to implement passive wireless communications, such as RFID communications, near-field communications (NFC), and/or various other backscatter modulation-based communications where the wireless tracker device receives and then reflects an interrogation signal as the carrier for information modulated onto the reflection by the tracker device. In examples where the tracker device is a wireless communication-capable tracker device, the tracker device can be implemented as and/or can include an RFID tag, such as the RFID tag 250 included in the RFID system 200 of FIG. 2.

For example, Radio Frequency Identification (RFID) systems can be used for short range wireless communication between a reader device (e.g., RFID reader) and one or more tags or transponders (e.g., RFID tags). An RFID reader may also be referred to as an “RFID interrogator,” and “RFID scanner,” and/or an “energizer.” RFID systems can be used to identify and/or track various items that are associated with one or more RFID tags (e.g., various items to which one or more RFID tags are attached). RFID systems can read and/or write information to and/or from (respectively) RFID tags, based on respective wireless communications between an RFID reader and the RFID tags. An RFID reader (e.g., energizer) can be used to interrogate one or more RFID tags to obtain information of the nearby items that are within communication range of the RFID reader and the interrogation signal. The RFID reader (e.g., energizer) can transmit a radio frequency (RF) signal to perform the energizing and interrogating of the RFID tags. An RFID tag that receives the interrogating RF wave can respond by backscattering (e.g., reflecting back) and/or transmitting another RF wave. An RFID tag may generate the responsive RF wave originally (e.g., in examples where the RFID tag is an active or semi-active tag). An RFID tag may generate the responsive RF wave passively, for instance by reflecting back a portion of the interrogating RFID wave using a backscatter process (e.g., in examples where the RFID tag is a passive tag).

In some examples (e.g., such as in product-related and/or service-related industries, etc.), RFID systems can be used to track objects that are being processed, inventoried, shipped, handled, etc. For example, an RFID tag can be attached to an individual item (e.g., to the packaging of an individual item, etc.) to provide tracking and identification of the individual item. In some examples, an RFID tag can be attached to a collection or group of individual items (e.g., to a pallet of same or similar items being shipped to a store or distribution center, etc.). An RFID tag attached to a respective item, or attached to a group of items, may store corresponding information thereof. For example, an RFID tag can include a data storage element that stores information corresponding to the item(s) to which the RFID is attached and associated. For instance, RFID tag information can include one or more of a product name, a serial number, product information, a manufacturer, etc. In some examples, the RFID tag can store identification information that is directly indicative of a tagged item, product, object, etc. For instance, an RFID tag can store identification information such as a unique product serial number, etc. In some examples, the RFID tag does not store product or item identification information directly, and stores a unique RFID tag serial number or identification number which may be externally mapped to various item identification information such as product serial numbers, product names, product SKUs, etc.

An RFID reader (e.g., energizer) can transmit an RF signal configured to cause the RFID tags to transmit at least a portion of their respective identification information. The RFID reader can receive (e.g., scan) the identification information transmitted by the one or more RFID tags energized by the RFID reader, and can use the identification information to determine the tagged items or products that are nearby to the RFID reader. In some examples, RFID tags can store item identification information that utilizes various granularity levels for tracking and management of the RFID tagged items. For example, RFID tags can be used to track item types or models by using different RFID tags (e.g., unique identifiers) per item type or item model, with RFID identifier reuse across individual tagged items that are of the same type or model. For instance, the RFID tags used for each item of a particular type may store the same product identifier, and can be used to decrement an inventory count for the particular item whenever a tag is scanned and removed from the shelf, from the store, etc.

In another example, RFID tags can be used to track and identify individual items, based on using a corresponding RFID tag and unique identifier for each individual item of a plurality of RFID-tagged items that are registered with the RFID system. In some examples, individual and unique item identifiers can be implemented based on using individual and unique RFID tag serial numbers or identifiers, which may be mapped separately to a corresponding individual item. In some examples, individual and unique item identifiers can be implemented based on using a product type identifier combined with a unique identifier within that product type. For instance, items can be tagged with their corresponding product SKU and a unique identifier of each item within the corresponding product SKU. In some cases, the unique RFID tag identifiers can be mapped in one or more databases to additional information associated with an item, such as manufacturing data, batch number, specific store location, etc.

In examples where the tracker device is a wireless communication-capable tracker device, the tracker device can be implemented as and/or can include an RFID tag, such as the RFID tag 250 included in the RFID system 200 of FIG. 2. For example, FIG. 2 illustrates an example of an RFID system 200 that includes an RFID reader (e.g., energizer) 210 and an RFID tag 250. RFID reader 210 may also be referred to as an interrogator, a scanner, an energizer, etc. RFID tag 250 may also be referred to as an RFID label, an electronic label, a tracker device, etc.

RFID reader 210 includes an antenna 220 and an electronics unit 230. Antenna 220 radiates signals transmitted by RFID reader 210 and receives signals from RFID tags (e.g., such as the RFID tag 250) and/or other devices. Electronics unit 230 may include a transmitter and a receiver for reading RFID tags such as RFID tag 250. The same pair of transmitter and receiver (or another pair of transmitter and receiver) may support bi-directional communication with wireless networks, wireless devices, etc. In some examples, a first RFID reader or RFID device can include a transmitter for energizing one or more RFID tags, and a second RFID reader or RFID device can include a receiver for receiving the reflected signals from the one or more RFID tags. For instance, an RFID reader can be configured to implement energizing and tag reading capabilities (e.g., includes a transmitter and a receiver), can be configured to implement energizing capabilities (e.g., includes a transmitter), and/or can be configured to implement tag reading capabilities (e.g., includes a receiver). The electronics unit 230 may include processing circuitry (e.g., a processor) to perform processing for data being transmitted and received by RFID reader 210.

RFID tag 250 includes an antenna 260 and a data storage element 270. Antenna 260 radiates signals transmitted by RFID tag 250 and receives signals from RFID reader 210 and/or other devices. For instance, RFID tags can be passive, active, or semi-active. Passive RFID tags utilize the interrogation signal from an RFID reader to power a transmission by or from the RFID tag. Active and semi-active RFID tags can include a power source or battery, which can be used to power a transmission by or from the RFID tag. In some examples, the RFID tag 250 may be a passive RFID tag having no battery. In this case, a magnetic field from a signal transmitted by RFID reader 210 (e.g., an energizing or interrogation signal from the RFID reader 210) may induce an electrical current in RFID tag 250, which may then operate based on the induced current. RFID tag 250 can radiate its signal in response to receiving a signal from RFID reader 210 or some other device.

The RFID tag 250 can use the data storage element 270 to store identification information corresponding to the RFID tag 250 and/or corresponding to an item associated with the RFID tag 250 (e.g., an item to which the RFID tag 250 is attached, etc.). For example, data storage element 270 can be used to store identification information using various granularity levels for tracking and management of an RFID tagged item. An RFID tag attached to a respective item, or attached to a group of items, may store corresponding information thereof. For example, the RFID tag 250 can be configured to store, using data storage element 270, identification information corresponding to the item(s) to which the RFID tag 250 is attached and associated. For instance, RFID tag information can include one or more of a product name, a serial number, product information, a manufacturer, etc. In some examples, the RFID tag 250 can store (e.g., using the data storage element 270) identification information that is directly indicative of a tagged item, product, object, etc. For instance, the RFID tag 250 can store identification information such as a unique product serial number, etc. In some examples, the RFID tag 250 does not store product or item identification information directly, and stores a unique RFID tag serial number or identification number corresponding to the RFID tag 250, which may be externally mapped to various item identification information such as product serial numbers, product names, product SKUs, etc. Data storage element 270 can be configured to store identification information for RFID tag 250, e.g., in an electrically erasable programmable read-only memory (EEPROM). RFID tag 250 may also include an electronics unit that can process the received signal and generate the signals to be transmitted.

RFID tag 250 may be read as follows. RFID reader 210 may be placed or moved within close proximity to RFID tag 250. RFID reader 210 may radiate a first signal (which is also called an interrogation signal) via its antenna 220. The energy of the first signal may be coupled from RFID reader antenna 220 to RFID tag antenna 260 via magnetic coupling and/or other phenomena. RFID tag 250 may receive the first signal from RFID reader 210 via antenna 260 and, in response, may radiate a second signal (which is also referred to as a responding signal) comprising the information stored in data storage element 270. RFID reader 210 may receive the second signal from RFID tag 250 via antenna 220 and may process the received signal to obtain the information sent in the second signal. RFID system 200 may be designed to operate at various frequencies and/or frequency ranges. For example, RFID system 200 can operate at 900 MHz, within a range of 860-960 MHz, etc., among various other example frequencies and/or frequency ranges of RFID operations. RFID reader 210 may have a specified maximum transmit power level, which may be imposed by the Federal Communication Commission (FCC) in the United Stated or other regulatory bodies in other countries. The specified maximum transmit power level of RFID reader 210 limits the distance at which RFID tag 250 can be read by RFID reader 210.

As noted previously, the systems and techniques described herein can be used to provide group management and context information for a virtual group or cohort of a plurality of tracker devices (e.g., smart envelopes, smart labels, etc.) that are configured to perform passive sensing. For example, the systems and techniques can be used to determine device context information and/or neighbor context information for various tracker devices of a plurality of tracker devices associated with a virtual group or cohort. The virtual group or cohort of tracker devices can be determined without wireless communications (or wired communications) between the respective tracker devices included in the plurality of tracker devices of the virtual group or cohort.

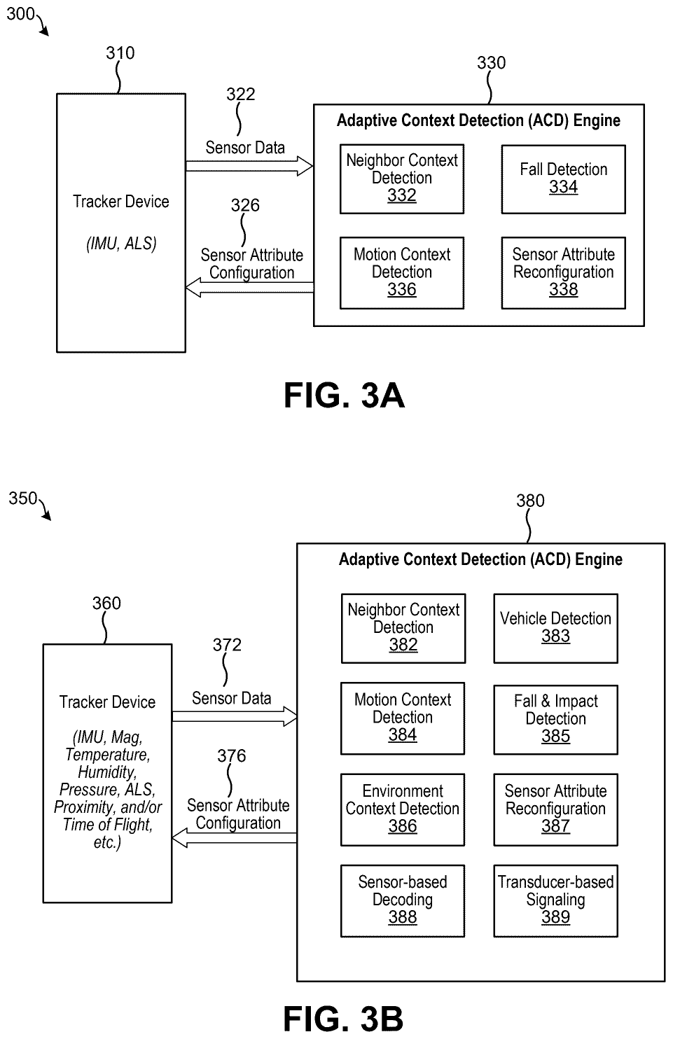

FIG. 3A is a diagram illustrating a first example of an architecture 300 of an adaptive context detection (ACD) engine 330 associated with a tracker device 310, in accordance with some examples. For example, the tracker device 310 can be implemented as a smart label, a smart envelope, and/or other smart tracking device, etc. In some aspects, the tracker device 310 may be a wireless communication-capable tracker device, and for example may include an RFID tag and/or transceiver configured to perform passive or backscatter communications, etc. In some examples, the tracker device 310 may be a non-wireless communication-capable tracker device, configured to obtain sensor data 322 from one or more sensors included in the tracker device 310 and process the obtained sensor data 322 locally.

In some aspects, smart devices (also referred to herein as “smart tracking devices”, etc., such as the tracker device 310) can include smart envelopes and/or objects with an attached smart label. In one illustrative example, a cellular smart label may be an example of a smart label (e.g., a “smart tracking label”), and can include an RFID tag and a small battery. For example, a cellular smart label may include a printed battery with a capacity of approximately 80-100 milliamp-hours (mAh). The cellular smart label may include an acceleration sensor (e.g., an accelerometer) and a proximity or ambient light sensor (ALS), among various other sensors that may be included within and/or implemented by the tracker device 310.

Different sensor values (e.g., included within the sensor data 322) obtained from the accelerometer and ALS included in the tracker device 310 can correspond to different context states for the tracker device 310. In some aspects, the context states for the tracker device 310 can comprise context information determined by an adaptive context detection (ACD) engine 330 that is associated with and/or implemented by the tracker device 310. For example, the ACD engine 330 can determine various types of context information for the tracker device 310, based on the ACD engine 330 processing sensor data 322 obtained by the one or more sensors included in the tracker device 310.

For example, the accelerometer and ALS of the tracker device 310 can be used to detect a motion state or a stationary state of the tracker device 310 (and/or the object to which the tracker device 310 is attached or otherwise associated with), can be used to perform vehicular motion detection, can be used to detect a covered state or an uncovered state, etc. In one illustrative example, the ACD engine 330 can utilize the sensor data 322 obtained from the one or more sensors included in the tracker device 310 to perform one or more of a neighbor context detection 332 (e.g., to determine neighbor context information associated with the tracker device 310), fall detection 334 (e.g., to determine a fall state corresponding to a fall event or no fall event detected for the tracker device 310), motion context detection 336 (e.g., to determine a motion context state or motion context information associated with the tracker device 310), and/or sensor attribute reconfiguration 338.

In some examples, the sensor attribute reconfiguration 338 can use the sensor data 322 and/or one or more of the other types of context information determined by the ACD engine 330 (e.g., the neighbor context information 332, the fall detection information 334, the motion context information 336, etc.) to generate as output a sensor attribute configuration information 326. The sensor attribute configuration information 326 can correspond to the sensor attribute reconfiguration block 338 included within or implemented by the ACD engine 330. In some aspects, the sensor attribute configuration information 326 can be used to change or update one or more configurations and/or sensor operation modes for one or more of the sensors included in the tracker device 310 (e.g., one or more of the sensors associated with the sensor data 322 provided as input to the ACD engine 330).

In some aspects, the example ACD architecture 300 of FIG. 3A can correspond to a smart label or smart envelope device (e.g., tracker device 310) that includes a set of hardware sensors comprising an IMU (or other acceleration sensor(s)) and an ALS (or other proximity sensor(s)). The ACD engine 330 can be configured to use the sensor data 322 received from the IMU and ALS hardware sensors of the tracker device 310 to perform various different context state detections for the tracker device 310. In some aspects, the different context state detections implemented by the ACD engine 330 can be based at least in part on the different types of sensor data that are included within the input sensor data 322 obtained by the tracker device 310 and provided to the ACD engine 330.

For instance, FIG. 3B is a diagram illustrating a second example of an architecture 350 of an adaptive context detection (ACD) engine 380 associated with a second tracker device 360, in accordance with some examples. In one illustrative example, the second tracker device 360 of FIG. 3B can be associated with a greater complexity than the tracker device 310 of FIG. 3A. In some cases, the greater complexity of the second tracker device 360 can correspond to a larger number of sensors, sensor modes, and/or sensor data 372 types that can be obtained by the included sensors of the second tracker device 360. For example, the relatively low complexity tracker device 310 of FIG. 3A may include an IMU and an ALS, configured to generate sensor data 322 that includes corresponding IMU or inertial data and corresponding ALS or proximity data for processing by the ACD engine 330.

The relatively high complexity tracker device 360 of FIG. 3B can include an IMU and an ALS, and may additionally include one or more of a magnetometer or magnetic sensor, a temperature sensor, a humidity sensor, a pressure or barometric sensor, a non-ALS-based proximity sensor, a Time-of-Flight (ToF) sensor, etc. The corresponding sensor data 372 generated by the second tracker device 360 can include additional sensor data streams and/or additional sensor information (e.g., different and additional sensor data types within the sensor data 372) corresponding to the additional physical hardware sensors that are included in the second tracker device 360 relative to the first tracker device 310.

The ACD engine 380 of FIG. 3B (e.g., associated with the relatively high complexity tracker device 360) can implement neighbor context detection 382 that is the same as or similar to the neighbor context detection 332 of FIG. 3A, motion context detection 384 that is the same as or similar to the motion context detection 336 of FIG. 3A, fall and impact detection 385 that may be similar to or include the fall detection 334 of FIG. 3A, and a sensor attribute reconfiguration 387 that may be the same as or similar to the sensor attribute reconfiguration 338 of FIG. 3A, etc.

In some aspects, the ACD engine 380 of FIG. 3B can include one or more additional types of context information detection or determination, for example based on the one or more additional types of sensors included in the tracker device 360 and the corresponding one or more additional types of sensor data included in the sensor data input 372 to the ACD engine 380. In one illustrative example, the ACD engine 380 can be configured to perform environment context detection 386, to determine environment context information of the tracker device 360 based on the sensor data 372. In some examples, the ACD engine 380 can be configured to perform vehicle detection 383 based on the sensor data 372 and/or to determine vehicle context information or vehicle detection state information corresponding to the tracker device 360 based on the sensor data 372. In another example, the ACD engine 380 can be configured to perform sensor-based decoding 388, based on the sensor data 372 of FIG. 3B. In some cases, the ACD engine 380 can be configured to perform transducer-based signaling 389, based at least in part on one or more portions of the sensor data 372, etc.

In some aspects, the ACD engine 380 can be configured to perform one or more of the context detection operations 382-389 based on fusing respective sensor data included in the sensor data input 372, where the respective sensor data are obtained from the multiple different physical sensors of the tracker device 360. Based on fusing of the different types of respective sensor data from one or more physical hardware sensors (e.g., passive sensors) of the tracker device 360, the ACD engine 380 can be configured to determine an increased number of different context states for the tracker device 360 (e.g., a greater quantity than the four context states and/or context determinations associated with the ACD engine 330 and the IMU and ALS sensor data input 322 of FIG. 3A, etc.).

In some cases, the ACD engine 380 can determine one or more types of context information that are associated with or indicative of a context of the tracker device 360. For example, the device context information can include one or more of the vehicle detection context 383, the fall and impact detection context 385, the motion detection context 384, a rotation and orientation detection context, etc.

The ACD engine 380 can additionally be configured to determine context information that corresponds to the tracker device 360 and one or more detected (e.g., nearby) neighboring tracker devices within the surrounding environment. For example, the ACD engine 380 can include context information such as a temperature context, a pressure context, a humidity context, an ambient light monitoring context, etc.

In one illustrative example, neighbor context detection can be performed by the ACD engine 330 of FIG. 3A and/or the ACD engine 380 of FIG. 3B to determine neighbor context information associated with the tracker device and one or more additional tracker devices (e.g., neighboring tracker devices) that are included in a same virtual group or cohort as the tracker device 310, 360. In some aspects, the neighbor context detection 332 performed by the ACD engine 330 of FIG. 3A can be the same as or similar to the neighbor context detection 382 performed by the ACD engine 380 of FIG. 3B.

In some aspects, the neighbor context detection performed by the ACD engine (e.g., the neighbor context detection 332 performed by the ACD engine 330 of FIG. 3A, and/or the neighbor context detection 382 performed by the ACD engine 380 of FIG. 3B, etc.) can be used to determine neighbor context information indicative of relative placement information between the respective tracker device (e.g., tracker device 310 or tracker device 360) and one or more neighboring tracker devices of the same virtual group or cohort. The one or more neighboring tracker devices can be detected based on the respective sensor data 322, 372 provided to the neighbor context detection block 332, 382 within the input sensor data 322, 372.

In one illustrative example, the neighbor context detection 332, 382 can be performed based on using one or more ALS and/or proximity sensors included in the tracker device 310, 360 to detect the presence and/or relative placement of one or more additional tracker devices of the same virtual group or cohort as the tracker device 310, 360. For example, an additional tracker device of the same virtual group or cohort that is placed nearby to the tracker device 310, 360 and within a threshold distance for detection using the one or more ALS and/or proximity sensors, can be referred to as a “neighboring tracker device” or “neighboring tracker” of the tracker device 310, 360 for which the neighbor context detection 332, 382 is performed.

In some aspects, an ALS sensor data indicative of an approximately zero-valued ALS sensor reading (e.g., an approximately zero ambient light value), or a relatively low ALS sensor reading corresponding to an amount of ambient light that is below a configured threshold or a detection threshold for the ALS sensor, can be used by the ACD engine 330, 380 to determine the placement of at least one neighboring tracking device nearby to the tracing device 310, 360. For example, a zero or low-valued ALS sensor data included in the input sensor data 322, 372 can be used by the ACD engine 330, 380 to infer that at least one neighboring tracker device is present with a placement nearby to (e.g., neighboring) the tracker device 310, 360.

In some aspects, the neighbor context information can be indicative of whether a neighboring tracker device is detected, or not detected, at each configured placement position or placement location relative to the tracker device 310, 360. For example, the one or more ALS sensors or proximity sensors used for the neighbor context detection can each be associated with a corresponding relative placement along a different side or orientation, and can be used by the ACD engine 330, 380 to generate a corresponding neighbor context information (e.g., placement of neighboring tracker device detected, or placement of neighboring tracker device not detected) for each respective location of an ALS or proximity sensor on the tracker device 310, 360. For example, the set of ALS or proximity sensors included in the tracker device 310 and/or the tracker device 360 can include a “left”, “right”, “top”, “bottom”, “front”, and/or “back”, etc., positioning information indicating the face or location of the tracker device 310, 360 for which the ALS or proximity sensor is oriented to perform the proximity sensing for the neighbor context detection or determination.

In some aspects, increased granularity may be associated with the placement or positioning information of the respective ALS or proximity sensors. For example, the tracker device 310, 360 may include a plurality of ALS or proximity sensors, with each respective ALS or proximity sensor of the plurality associated with a particular position selected from the example set of different neighbor detection positions (e.g., relative placement locations or positions, with respect to the tracker device 310, 360), where the example set of different neighbor detection positions comprises one or more (or all) of: “upper left”, “lower left”, “front left”, “back left”; “upper right”, “lower right”, “front right”, “back right”; “upper front”, “lower front”, “left front”, “right front”; “upper back”, “lower back”, “left back”, “right back”; “front top”, “back top”, “left top”, “right top”; “front bottom”, “back bottom”, “left bottom”, “right bottom”; etc.

For example, the placement of a neighboring tracker device nearby (e.g., on, adjacent to, etc.) the tracker device 310, 360 can block light from reaching the ALS or can reduce the ambient light reaching the ALS. In some cases, a relatively low ALS sensor value can correspond to a ‘Neighbor Context=Yes’ state detection, and a relatively high ALS sensor value can correspond to a ‘Neighbor Context=No’ state detection. Each Neighbor Context information or neighbor context detection can be associated to the particular detection position of the corresponding ALS or proximity sensor on the tracker device 310, 360. For example, the neighbor context information for an ALS or proximity sensor located at the “back left” detection position on the tracker device 310, 360 can be indicative of ‘Neighbor Context, Back Left=No’, etc.

In some examples, the motion context information of the tracker device 310, 360 can be determined by the motion context detection 336, 384 of the ACD engine 330, 380, based on IMU and/or other inertial or accelerometer data included in the respective input sensor data 322, 372. For example, the Motion Context Detection information can correspond to motion context information indicative of ‘Motion Context=Yes’, or ‘Motion Context=No’, etc., indicating whether the tracker device 310, 360 is detected as being in a motion or moving state, or in a non-motion or stationary state, etc. In another illustrative example, the fall detection 334 of the ACD engine 330 and/or the fall and impact detection 385 of FIG. 3B can use the IMU and/or other inertial sensor data included in the respective input sensor data 322, 372 to determine if the tracker device 310, 360 is falling or has fallen (e.g., ‘Fall Event=Yes’) or if the tracker device 310, 360 is not currently falling (e.g., ‘Fall Event=No’).

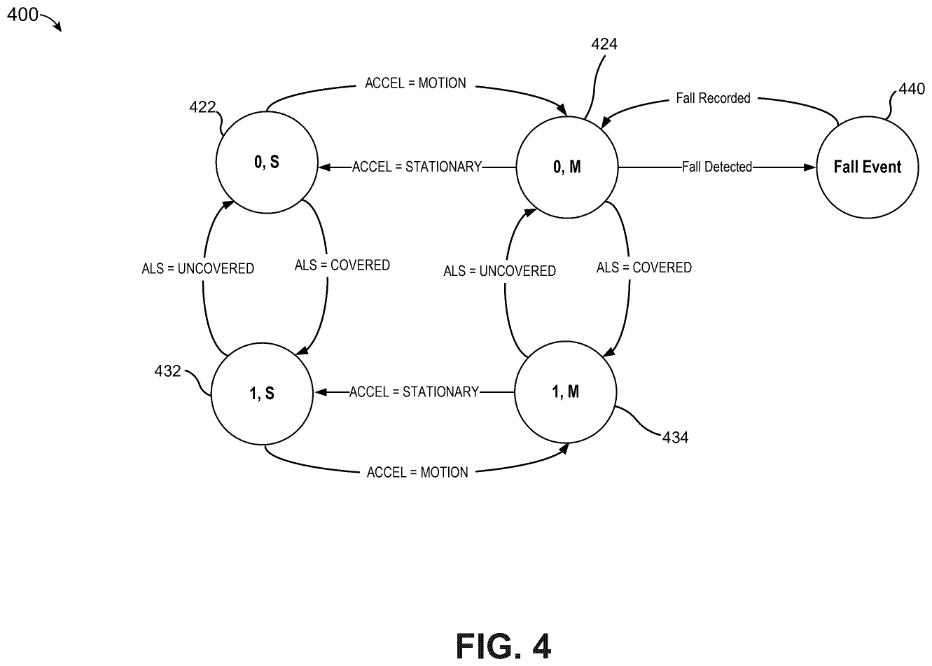

FIG. 4 is a diagram illustrating an example state machine flow 400 corresponding to the ACD engine 330 and hardware context information associated with the tracker device 310 of FIG. 3A, in accordance with some examples. In some aspects, the hardware context associated with the state machine 400 can include an ALS or proximity sensor state (e.g., context) with a value of ‘Uncovered’ or ‘Covered’. The hardware context of the state machine 400 can additionally include an accelerometer sensor state (e.g., context) with a value of ‘Stationary’ (e.g., S), ‘Motion’ (e.g., M), or ‘Fall’.

In the example of FIG. 4, the state machine 400 includes a first state 422 (e.g., labeled the ‘0,S’ state), corresponding to a determination that the tracker device 310 has no neighbors detected and is currently stationary (e.g., S). The state machine 400 includes a second state 424 (e.g., labeled the ‘0,M’ state), corresponding to a determination that the tracker device 310 has no neighbors detected and is currently moving (e.g., M). The transition from the (0,S) state 422 to the (0,M) state 424 is based on sensor information (e.g., device context, motion context, etc.) corresponding to or indicative of an Accel=Motion state transition. The transition from the (0,M) state 424 to the (0,S) state 422 is based on sensor information corresponding to or indicative of an Accel=Stationary state transition.

The state machine 400 includes a third state 432 (e.g., labeled the ‘1,S’ state), corresponding to a determination that the tracker device 310 has one neighbor and is currently stationary. The transition between the (0,S) state 422 to the (1,S) state 432 can be based on an ALS=Covered neighbor context information. The transition from the (1,S) state 432 to the (0,S) state 422 can be based on an ALS=Uncovered neighbor context information.

The state machine 400 can include a fourth state 434 (e.g., labeled the ‘1,M’ state), corresponding to a determination that the tracker device 310 has one neighbor and is currently moving. The transition from the (1,S) state 432 to the (1,M) state 434 can be based on an Accel=Motion device or motion context information. The transition from the (1,M) state 434 to the (1,S) state 432 can be based on an Accel=Stationary device or motion context information. The transition from the (1,M) state 434 to the (0,M) state 424 can be based on an ALS=Uncovered neighbor context information. The transition from the (0,M) state 424 to the (1,M) state 434 can be based on an ALS=Covered neighbor context information.

The state machine 400 can further include a fall event state 440, corresponding to an error event that is configured for or corresponding to an indication or determination that a fall has occurred or is occurring for the tracker device 310. For example, the fall event error state 440 can be reached from the (0,M) state 424, with a state transition corresponding to a fall detection context event or information. The state machine 400 can exit the fall event error state 440 by the transition from the fall event state 440 to the (0,M) state 424, based on a state transition corresponding to a fall recorded context event or information.

Table 1, below, provides details of the different state transitions and corresponding sensor values of the ALS and accelerometer (e.g., IMU) of the state machine 400, which can be implemented for or by the ACD engine 330 of the tracker device 310 of FIG. 3A, and/or the ACD engine 380 of the tracker device 360 of FIG. 3B. Each tracker device of a plurality of tracker devices included in or associated with the same virtual group or cohort of tracker can independently implement the state machine 400 of FIG. 4, and can determine the corresponding motion state (motion or stationary) and neighbor state (no neighbors or at least one neighbor) of the respective tracker device independently from the state determinations or state information associated with the remaining tracker devices of the virtual group or cohort. In one illustrative example, each state machine 400 instance can be implemented independently, to determine state information (e.g., neighbor context, motion context, device context, error event or error event context, etc.), without the corresponding tracker device 310, 360 performing communications with any of the remaining tracker devices (or associated state machine 400 instances for each of the remaining tracker devices) of the virtual group or cohort.

TABLE 1
Example state machine transitions for an ACD state machine
associated with and/or implemented by a tracker device.

| Tracker | Example State | Sensor States | | Entry Condition | |
|---|---|---|---|---|---|
| State | Description | ALS | Accel | Init. State | Condition |
| 0, S | Regular mail with | Uncovered | Stationary | 0, M | Accel detects |
| | no neighbors | | | | stationary state |
| | covering the ALS, | | | 1, S | ALS is uncovered |
| | and stationary | | | | |
| 0, M | Regular mail with | Uncovered | Motion | 0, S | Accel detects |
| | no neighbors | | | | motion state |
| | covering the ALS, | | | 1, M | ALS is uncovered |
| | and in motion | | | Fall | Fall is |
| | | | | Event | recorded/logged |
| 1, M | Regular mail with a | Covered | Motion | 1, S | Accel detects |
| | neighbor covering | | | | motion state |
| | the ALS, and in | | | 0, M | ALS is covered |
| | motion | | | | |
| 1, S | Regular mail with a | Covered | Stationary | 1, M | Accel detects |
| | neighbor covering | | | | stationary state |
| | the ALS, and | | | 0, S | ALS is covered |
| | stationary | | | | |
| Fall | A state to record a | Uncovered | Motion | 0, M | Accel detects fall |
| Event | fall event | | | | |

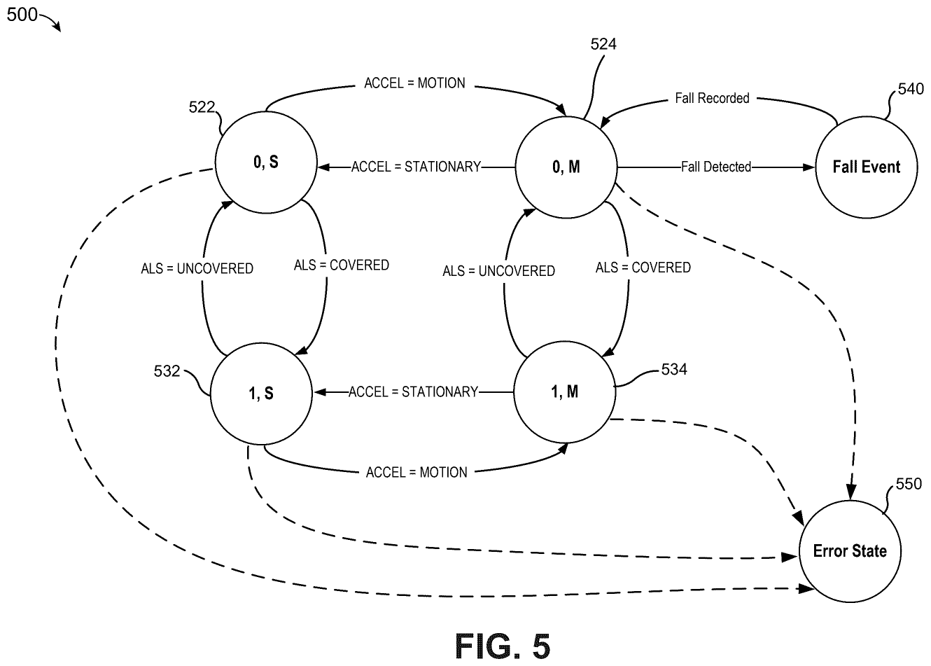

FIG. 5 is a diagram illustrating an example state machine 500 flow that includes a fall event error state 540 and one or more additional error states 550. For example, the state machine flow 500 of FIG. 5 can be the same as the state machine flow 400 of FIG. 4, with the addition of the additional error state 550 and corresponding state transitions from each of the four states 522, 524, 532, 534 to the additional error state 550.

In some aspects, the (0,S) state 522 of FIG. 5 can be the same as the (0,S) state 422 of FIG. 4; the (0,M) state 524 of FIG. 5 can be the same as the (0,M) state 424 of FIG. 4; the (1,S) state 532 of FIG. 5 can be the same as the (1,S) state 432 of FIG. 4; the (1,M) state 534 of FIG. 5 can be the same as the (1,M) state 434 of FIG. 4; and/or the fall event state 540 of FIG. 5 can be the same as the fall event state 440 of FIG. 4.

In some aspects, the additional error state 550 can also be referred to as a “hazard state”, and can be used for functions such as theft detection, shock detection, hazard detection (e.g., fire, high humidity, etc.), among various others. In some cases, entry to the additional error state 550 (e.g., additional hazard state) can be based on a state transition from one of the four states 522, 524, 532, 534 of the state machine 500 flow. For example, entry to the additional error state 550 can be triggered based on various combinations of sensor data, including fused sensor data values obtained from multiple different hardware sensors of the tracker device 310 and input sensor data 322 to the ACD engine 330 of FIG. 3A, and/or the tracker device 360 and input sensor data 372 to the ACD engine 380 of FIG. 3B, etc. For example, entry to an additional error state 550 comprising a theft detection hazard or error state can correspond to detecting a sudden change in the ALS value while the tracker is in a moving vehicle. In another example, entry to an additional error state 550 comprising a shock detection hazard or error state can use a fast jerk action detected by the IMU as a criteria. For entry to an additional error state 550 comprising a fire hazard detection hazard or error state, a change in the temperature sensor reading(s) over a configured time window can be used as a criteria, etc.

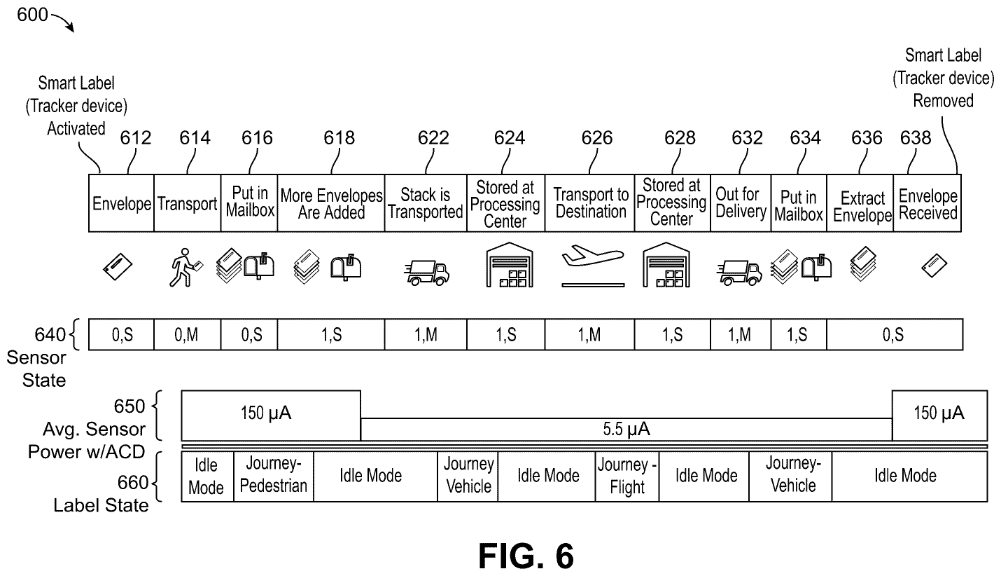

FIG. 6 is a diagram 600 illustrating an example of ACD state information and ACD state transitions for a tracker device included in a virtual group or cohort of a plurality of tracker devices, in accordance with some examples. For example, the diagram 600 corresponds to a plurality of time instances 612-638, where the smart label (e.g., tracker device) is activated at or before the first time instance 612, and is deactivated or removed during or after the last time instance 638.

Each of the time instances 612-638 is associated with a corresponding sensor state 640, which can be selected from the ACD state machine states (0,S), (1,S), (0,M), (1,M), etc., associated with the state machine 400 of FIG. 4 and/or the state machine 500 of FIG. 5, etc. Each of the time instances 612-638 is further associated with an average sensor power 650 with ACD utilized, and a label state information 660.

In some aspects, the diagram 600 corresponds to an example deployment lifecycle of the ACD state information corresponding to a tracker device (e.g., tracker device 310 of FIG. 3A, tracker device 360 of FIG. 3B, etc.) that is included in a virtual group or cohort of additional tracker devices. For example, the tracker device associated with the diagram 600 can be a smart label or smart envelope that is bundled together with a plurality of additional smart labels or envelopes for transportation and storage. The bundled group of smart labels or smart envelopes can comprise the virtual group or cohort of tracker devices.

In some aspects, the sensor state information 640 utilizes the same state definitions as the state machine 400 of FIG. 4 and/or the state machine 500 of FIG. 5. IN some examples, an “Avg. Sensor Power w/o ACD” may represents the average power consumption of a tracker device's hardware sensors when the systems and techniques described herein are not used (e.g., the average power is constant at a high-power consumption level of 150 uA). In some aspects, the “Avg Sensor Power w/ACD” information 640 represents the average power consumption of a tracker device's included hardware sensors when utilizing the systems and techniques described herein, including the ACD engine 330 of FIG. 3A and/or the ACD engine 380 of FIG. 3B (e.g., corresponding to implementing one or more of the example ACD state machines 400 of FIG. 4, 500 of FIG. 5, etc.)

In one illustrative example, the use of the ACD allows the tracker device to reduce its sensor power consumption whenever the tracker device determines the placement of an additional tracker device of the virtual group or cohort, such that the placement makes the additional tracker device a neighboring tracker device. For example, the neighbor context information can be indicative of the placement of a neighboring tracker device when the sensor state 640 indicates the ‘1,S’ state or the ‘1,M’ state, both of which correspond to scenarios where the smart envelope (e.g., tracker device) is not at the top of the stack of bundled envelopes of the virtual group or cohort.

In some aspects, when the ACD detects that the smart envelope (e.g., tracker device) is moving and has no neighbors (e.g., is at the top of the stack, corresponding to the ‘0,M’ sensor state 640), the ACD can configure the smart envelope (e.g., tracker device to operate in the full-power mode, as indicated in the average sensor power with ACD information 650 for the plurality of time instances 612-638.

In some examples, when the ACD detects that the smart envelope (e.g., tracker device) is stationary (e.g., either the ‘0,S’ or the ‘1,S’ sensor state 640), the ACD can configure the smart envelope (e.g., tracker device to enter an Idle Mode to reduce power consumption for the particular time instances within the plurality of time instances 612-638 where the sensor state 640 is (0,S) or (1,S).

In some aspects, when the ACD detects that the smart envelope (e.g., tracker device) is both stationary and covered by at least one neighbor (e.g., the ‘1,S’ sensor state 640), the ACD can configure the smart envelope (e.g., tracker device) to enter an ultra-low power mode as the configured power mode information 660 for the tracker device of the diagram 600. When the ACD detects that the smart envelope (e.g., tracker device) is moving and covered by at least one neighbor (e.g., the ‘1,M’ sensor state 640), the ACD can configure the smart envelope (e.g., tracker device) to enter a regular or normal low-power mode as the configured power mode information 660 for the tracker device of the diagram 600, based on more frequent monitoring being performed for the smart envelope (e.g., tracker device) during transit/while in motion.

In another illustrative example, a smart tracker device (e.g., tracker device 310 of FIG. 3A, tracker device 360 of FIG. 3B, etc.) may include one or more RFID tags and a relatively larger battery capacity that supports a greater number of integrated or embedded sensors within the tracker device. For example, a tracker device may include an IMU, a pressure sensor, a temperature sensor, a humidity sensor, and a proximity/ALS sensor. A greater number of context states can be detected or inferred based on the various combinations of sensor data values obtained from the sensors included in the tracker device. For example, the different context states for the tracker device may include motion/stationary detection, vehicular motion detection, anti-theft detection, flight mode detection, environmental monitoring, impact detection, fall detection, refrigerated/non-refrigerated detection, etc.

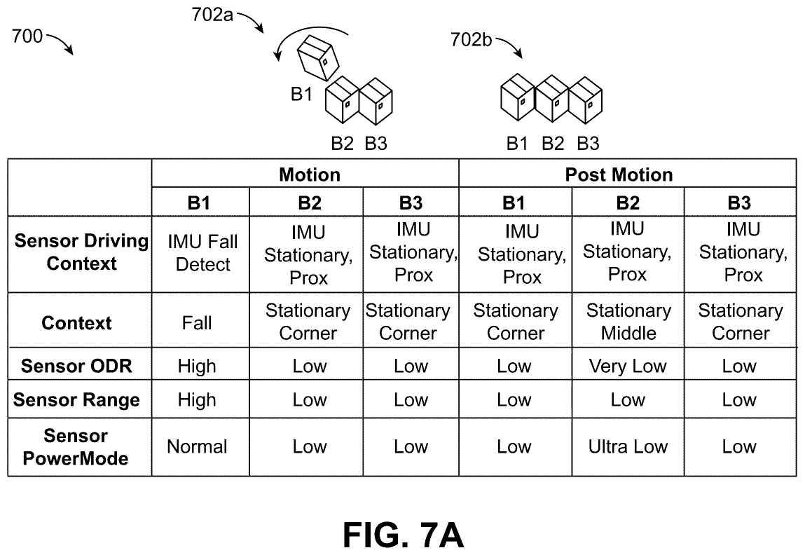

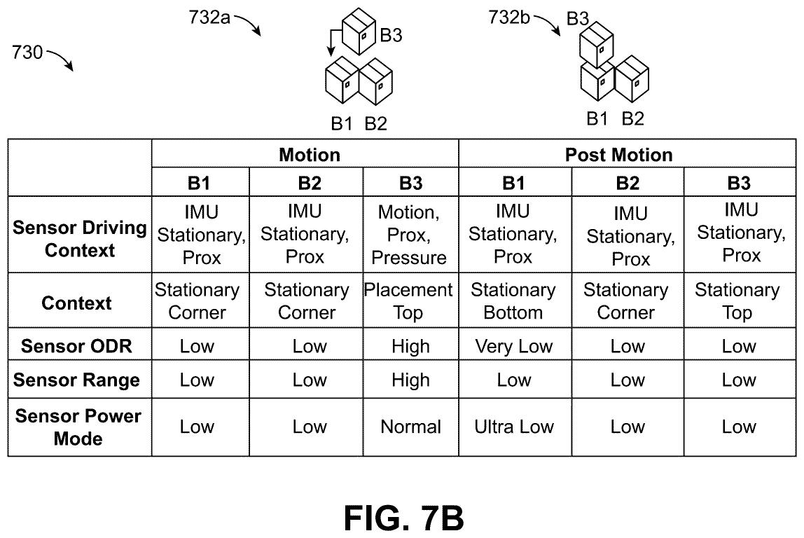

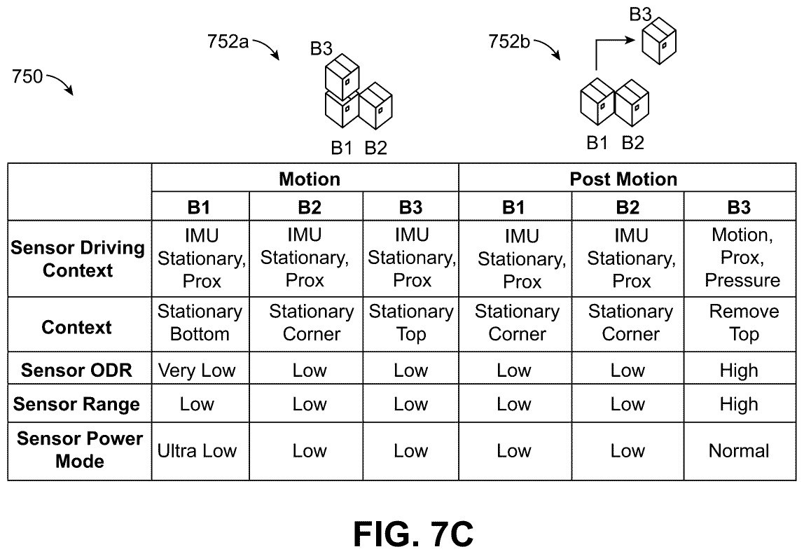

FIGS. 7A-7C illustrate examples of respective ACD state information and ACD state transitions for a virtual group of tracker devices associated with packages, in accordance with some examples. In some aspects, the virtual group or cohort of tracker devices can correspond to a plurality of tracker devices that are implemented as smart labels or other tracker devices each affixed to a corresponding box or package, for example within a warehouse context or example warehouse sensing and tracking scenario.

In one illustrative example, a smart envelope, smart label, or smart tracker device (e.g., the tracker device(s) described herein) can include multiple instances of the same sensor type provided at different locations on and/or within the tracker device. For example, a box or package can be associated with smart labels or smart trackers that provide ALS sensors at different locations such as top, bottom, side, corner, middle, etc., which can be used to perform neighbor context detection with increased granularity.

In some aspects, FIG. 7A illustrates an example ACD-based sensing example 700, corresponding to a first time instance 702a where a first box B1 with an attached tracker device falls off the top of a pile of boxes including additional boxes B2 and B3, each with a respective attached tracker device. In a later, or second, time instance 702b, the box B1 has completed its fall and now sits in a placement adjacent to the side of the box B2.

In this example, box B1 falls to the bottom of the pile and comes to rest nearby to the boxes B2 and B3 (e.g., where boxes B2 and B3 are already at the bottom of the pile), at time instance 702a. This results in the ACD reconfiguring the sensors of B1 to a high-power, high-range, and high output data rate (ODR) in response to a Fall detection (e.g., a ‘Fall’ context for B1), indicated in the respective ACD state information shown in FIG. 7A for box B1 at the later time instance 702b. After the fall (e.g., during later time instance 702b), the neighbors B2 and B3 determine the context of the fallen box B1, and the respective ACD running for each neighbor can perform reconfiguration accordingly. For example, the ACD of box B2 can reconfigure B2 to enter a very low-power mode (e.g., ultra-low power mode) due to the neighborhood of B1 and B3 surrounding B2 to the left and right, respectively. After the fall, the ACD of box B1 can reconfigure B1 to a low-power mode, as the high-power, high-range, and high ODR configured during the Fall event are no longer needed for box B1 when stationary.

During the first time instance 702a corresponding to box B1 falling off the top of the stack of boxes B1, B2, B3, the ACD state machine implemented by the tracker device attached to box B1 is associated with the following information: Sensor Driving Context=IMU-based Fall Detected; Context=Fall; Sensor Output Data Rate (ODR)=High; Sensor Range=High; Sensor Power Mode=Normal. The ACD state machine implemented by the tracker device attached to box B2 is associated with the following ACD state information: Sensor Driving Context=IMU-based Stationary, Proximity; Context=Stationary Corner; Sensor ODR=Low; Sensor Range=Low; Sensor Power Mode=Low. The ACD state machine implemented by the tracker device attached to box B3 is associated with the following ACD state information: Sensor Driving Context=IMU-based Stationary, Proximity; Context=Stationary Corner; Sensor ODR=Low; Sensor Range=Low; Sensor Power Mode=Low.

After the box B1 has fallen, during the later time instance(s) 702b, the ACD state machine implemented by the tracker device attached to box B1 is updated to indicate the following ACD state information: Sensor Driving Context=IMU-based Stationary, Proximity; Context=Stationary Corner; Sensor Output Data Rate (ODR)=Low; Sensor Range=Low; Sensor Power Mode=Low.

After the box B1 has fallen, during the later time instance(s) 702b, the ACD state machine implemented by the tracker device attached to box B2 updates with the ACD state information indicating: Context=Stationary Middle, Sensor ODR=Very Low (e.g., ultra-low), Sensor Power Mode=Ultra Low.

After the box B1 has fallen, during the later time instance(s) 702b, the ACD state machine implemented by the tracker device attached to box B3 determines the same ACD state information as prior to the update (e.g., same ACD state information during time instance 702a and later time instance 702b).

In another illustrative example, as shown in the example 730 of FIG. 7B, at a first time instance 732a a third box B3 is placed on top of the stack of boxes comprising box B1 and box B2. In a later time instance 732b, the box B3 is at rest in its new placement on top of the existing stack of boxes B1 and B2. Based on the placement of box B3 between time instances 732a and 732b, the ACD implemented by the tracker device attached to box B3 can determine ACD state information corresponding to reconfiguring the sensors of B3 from high-power, high-range, and high ODR on Fall detection (e.g., during the placing motion of time instance 732a when box B3 is placed on top of box B1) to a low-power mode at the later time instance 732b after box B3 is determined to have left the ‘Fall’ detection state to now be at rest, stationary but on top of another device (e.g., box B1). Box B1 is determined to have one neighbor and in a stationary state. Accordingly, box B1 is reconfigured by the ACD to enter a very low-power (e.g., ultra-low power) mode, based on transitioning from ‘Stationary Corner’ to ‘Stationary Middle’.

In another illustrative example, FIG. 7C depicts an example scenario 750 where a box B3 is initially in a placement on top of boxes B1 and B2 at a first time instance 752a. At a later time instance 752b, the box B3 is lifted off and removed from its placement on top of boxes B1 and B2. For example, FIG. 7C illustrates the corresponding ACD state information and changes (e.g., ACD state transitions) decisions corresponding to detection of the removal of the box B3 device from the virtual group or cohort of devices, between time instance 752a and later time instance 752b (e.g., each of B1, B2, B3 independently implements its own respective ACD/state machine and corresponding ACD decisions as shown in FIG. 7C).

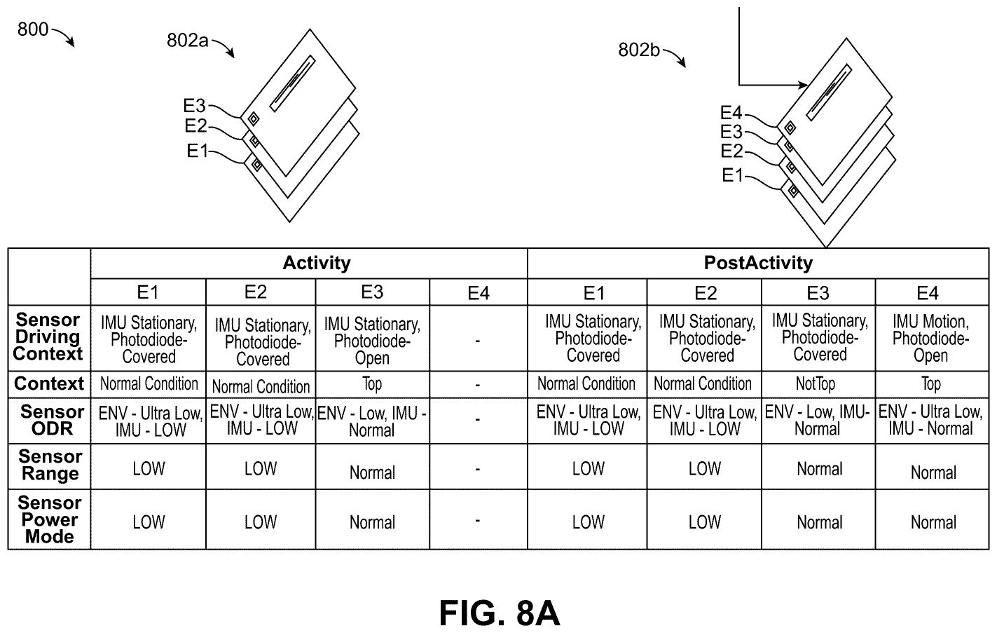

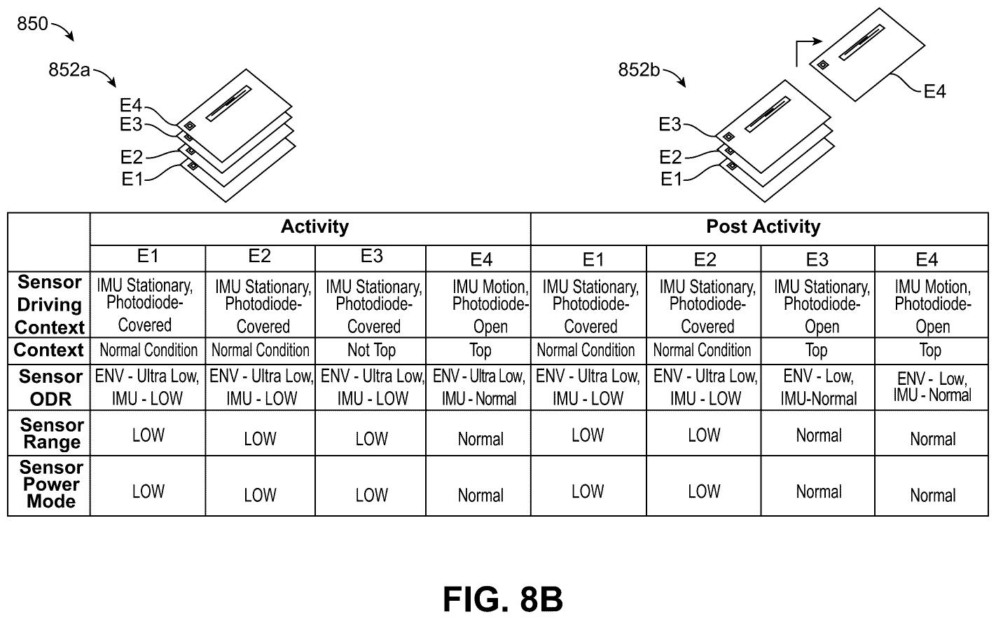

FIGS. 8A-8B illustrate examples of respective ACD state information and ACD state transitions for a virtual group of tracker devices comprising smart labels attached to envelopes or mail pieces, in accordance with some examples. For example, FIG. 8A illustrates a first example scenario 800, where in a first time instance 802a a stack of smart envelopes (e.g., envelopes included or with an affixed tracker device) comprises a bottom envelope E1, a middle envelope E2, and a top envelope E3. In a later time instance 802b, the stack of envelopes (e.g., the virtual group or cohort of tracker devices) adds a new envelope E4 as the top envelope, with the envelope E3 now a middle or interior stack envelope like the envelope E2. The envelope E1 remains the bottom of the stack in the later time instance 802b.

In the first time instance 802a, envelope E1 and envelope E2 each have a sensor driving context of IMU Stationary, Photodiode-Covered. The top envelope E3 has a sensor driving context of IMU Stationary, Photodiode-Open. The envelopes E1 and E2 each have a context of ‘Normal Condition’, while the top envelope E3 has a context of ‘Top’. The sensor ODR for the bottom envelope E1 and the middle envelope E2 can be set to ENV-Ultra Low, IMU-Low. The sensor ODR for the top envelope E3 can be set to ENV-Low, IMU-Normal. The sensor range for the bottom envelope E1 and the middle envelope E2 can both be set to Low, while the sensor range for the top envelope E3 can be set to Normal. The Sensor Power Mode for the bottom envelope E1 and the middle envelope E2 can both be set to Low, while the Sensor Power Mode for the top envelope E3 can be set to Normal.

At the later time instance 802b, the top envelope is now E4, and the previous top envelope E3 is now a middle/interior envelope, along with E2.

The sensor driving context for bottom envelope E1 and middle envelope E2 can each be set to IMU Stationary, Photodiode-Covered, while the middle envelope E3 and the new top envelope E4 are set to IMU Motion, Photodiode-Covered and IMU Motion, Photodiode-Open, respectively. The Context is set to ‘Normal Condition’ for envelopes E1 and E2, ‘Not Top’ for envelope E3, and ‘Top’ for the new top envelope E4. The Sensor ODR is set to ENV-Ultra Low, IMU-Low for the envelopes E1 and E2, and is set to ENV-Low, IMU-Normal for the envelope E3. The Sensor ODR is set to ENV-Ultra Low, IMU-Normal for the new top envelope E4. The Sensor Range is set to ‘Low’ for envelopes E1 and E2, and is set to ‘Normal’ for envelopes E3 and E4. The Sensor Power Mode is set to ‘Low’ for envelopes E1 and E2, and is set to ‘Normal’ for envelopes E3 and E4.

FIG. 8B illustrates another example scenario 850, where in a first time instance 852a a virtual group or cohort comprises the stack of smart envelopes (e.g., envelopes each including or integrating a respective tracker device and ACD engine and/or ACD state machine instance, etc.) with the bottom envelope E1, middle/interior envelopes E2 and E3, and top envelope E4. At a later time instance 852b, the prior top envelope E4 is removed from the stack, and the new top envelope becomes the envelope E3.

In the first time instance 852a, the Sensor Driving context is IMU Stationary, Photodiode-Covered for envelopes E1, E2, and E3; and is IMU Motion, Photodiode-Open for the removed envelope E4. The Context is Normal Condition for envelopes E1 and E2, Not Top for envelope E3, and Top for envelope E4. The Sensor ODR is ENV-Ultra Low, IMU-Low for envelopes E1, E2, and E3; and is ENV-Ultra Low, IMU-Normal for the envelope E4. The Sensor Range and Sensor Power Mode are both set to ‘Low’ for the envelopes E1, E2, and E3; and are both set to ‘Normal’ for the envelope E1.

In the later time instance 852b, the Sensor Driving context is IMU Stationary, Photodiode-Covered for envelopes E1 and E2; is IMU Stationary, Photodiode-Open for envelope E3; and is IMU Motion, Photodiode-Open for envelope E4. The Context is Normal Condition for envelopes E1 and E2; and is Top for envelopes E3 and E4. The Sensor ODR is ENV-Ultra Low, IMU-Low for envelopes E1 and E2; is ENV-Low, IMU-Normal for envelope E3; and is ENV-Low, IMU-Normal for the envelope E4. The Sensor Range and Sensor Power Mode are each set to ‘Low’ for envelopes E1 and E2; and are each set to ‘Normal’ for envelopes E3 and E4.

In some aspects, different reconfiguration options may be implemented based on the detected hardware context states (e.g., including neighbor/group context states, environment context states, etc.) of a tracker device, and can vary per sensor or sensor type. For example, the reconfiguration options can correspond to different power operation modes for the sensor (e.g., high, low, ultra-low, normal, etc.). In some examples, the reconfiguration options can correspond to different sampling rates for the sensor (e.g., high, low, ultra-low, normal, etc.). In some aspects, the reconfiguration options can correspond to different modes of operation for the sensor, for instance increasing or decreasing the dynamic range of the sensor, increasing or decreasing the output data rate (ODR) of the sensor, enabling or disabling internal filters or components of the sensor, etc.

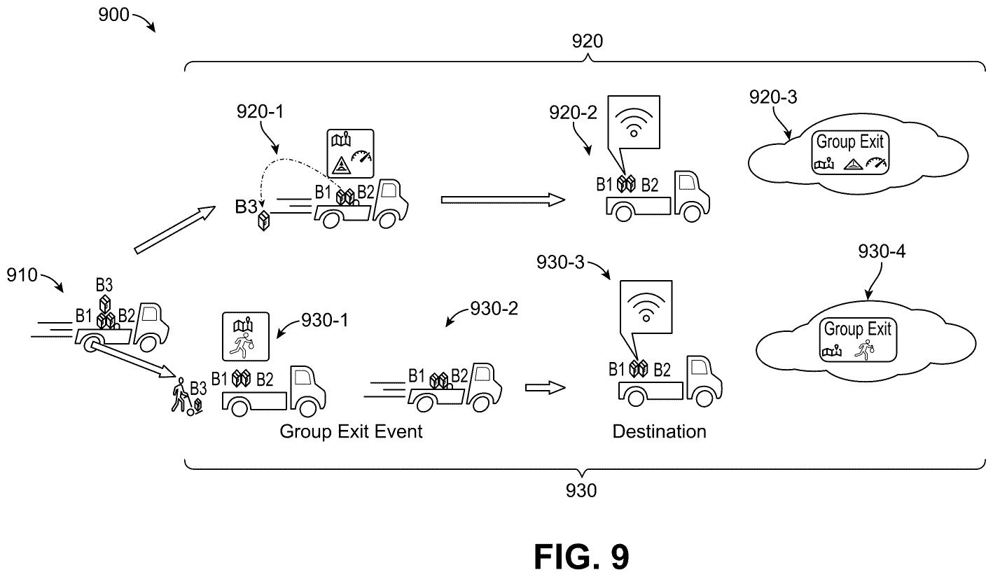

FIG. 9 is a diagram illustrating an example of virtual group sensor data collection 900, where information can be inferred based on group sensor data and/or group sensor information corresponding to a virtual group of a plurality of tracker devices, in accordance with some examples. For example, each tracker device of the plurality of tracker devices associated with a same virtual group or cohort of tracker devices can maintain group information, based on each respective tracker device obtaining sensor data according to the neighbor context information of the tracker device. For example, the top or top-most tracker device of the group will determine neighbor context information indicating that there is not a placement of an additional neighboring device on top. The top-most tracker device therefore determines it is the tracker device on the top of the stack, and may collect sensor data with a higher ODR, increased complexity, increased number or types of sensors, etc. The top-most tracker device may collect sensor data using a higher power consumption or power mode of sensor operation than the tracker devices that determine respective context information indicating that the tracker device is not currently in a placement at the top of the stack, based on the respective neighbor context information of each of the tracker devices. The collected sensor data obtained by the individual tracker devices of the virtual group or cohort of tracker devices may later be collected or read from the tracker devices, for example by a reader devices (or reader devices) at the destination of the transit or movement action for the plurality of tracker devices of the virtual group or cohort.

Based on each tracker device maintaining group information (e.g., including state history change information for the neighbor context information determined by each respective tracker device at various different time instances), abnormal events, error conditions, hazard events or hazard conditions, etc., can be tracked and backfilled later by using data obtained by other tracker devices of the same cohort at the same time instance(s). For example, in the case of the loss of a device of the virtual group or cohort (e.g., the lost tracker device is no longer nearby and/or moving with the remaining tracker devices of the virtual group or cohort, due the lost tracker device falling off or becoming lost during transit, being stolen or improperly removed, etc.).

For example, at time instance 910 of FIG. 9, a plurality of tracker devices associated with the plurality of boxes B1, B2, and B3 are placed on a vehicle for transit to an intended destination. The virtual group of boxes including boxes B1, B2, and B3 begin moving together starting from time instance 910.

In a first example flow 920, after time instance 910, at a later time instance 920-1, the box B3 falls off of the stack being transported by the vehicle. Based on box B3 being in a placement on top of the boxes B1 and B2 (e.g., prior to box B3 falling off the vehicle), both boxes B1 and B2 may determine, independently, respective ACD state information indicative of a state change where box B1 determined it was a top-of-stack placement and box B2 determined it was a top-of-stack placement. For instance, when box B3 falls off the top of the stack, the remaining boxes B1 and B2 that were previously adjacent to (e.g., below) box B3, will determine at approximately the same time that their state has changed from an interior/non-top-of-stack placement to a new, top-of-stack placement.

Based on correlating and identifying the common time where the ACD state information changed for the boxes B1 and B2, information indicative of the time of loss of the box B3 can be determined or inferred from the sensor information collected and maintained (e.g., stored) by the remaining boxes B1 and B2. For example, at a later time 920-2, transit continues with boxes B1 and B2 on the vehicle and box B3 no longer on the vehicle. At the later time 920-2, one or more reader devices may be used to read the respective sensor data and/or ACD state information and change history information from the boxes B1 and B2. The offloaded information from the tracker devices of boxes B1 and B2 can be provided to a cloud platform or remote server for analysis, and at time instance 920-3 a group exit event can occur or can be determined, corresponding to the loss of the box B3 and the time instance 920-1, based on the concurrent state changes initiated by the remaining boxes B1 and B2 in response to the loss of box B3 at time instance 920-1.

In another example flow 930, after the initial transit of boxes B1, B2, and B3 at time instance 910, a group exit event can occur across time instance 930-1 and 930-2. At time instance 930-1, the box B3 is offloaded per a pre-determined delivery plan or scheduled, leaving only the boxes B1 and B2 remaining at time instance 930-2. For example, the group exit event can be determined or inferred based on the boxes B1 and B2 each initiating respective ACD state information changes, reflecting the updated state of both boxes B1 and B2 as top-level placement packages. At time instance 930-3, the process can be the same as or similar to time instance 920-2 as described above, and at time instance 930-4, the cloud processing can be performed to identify the group exit event, the same as or similar to the cloud processing at time instance 920-3, as described above.

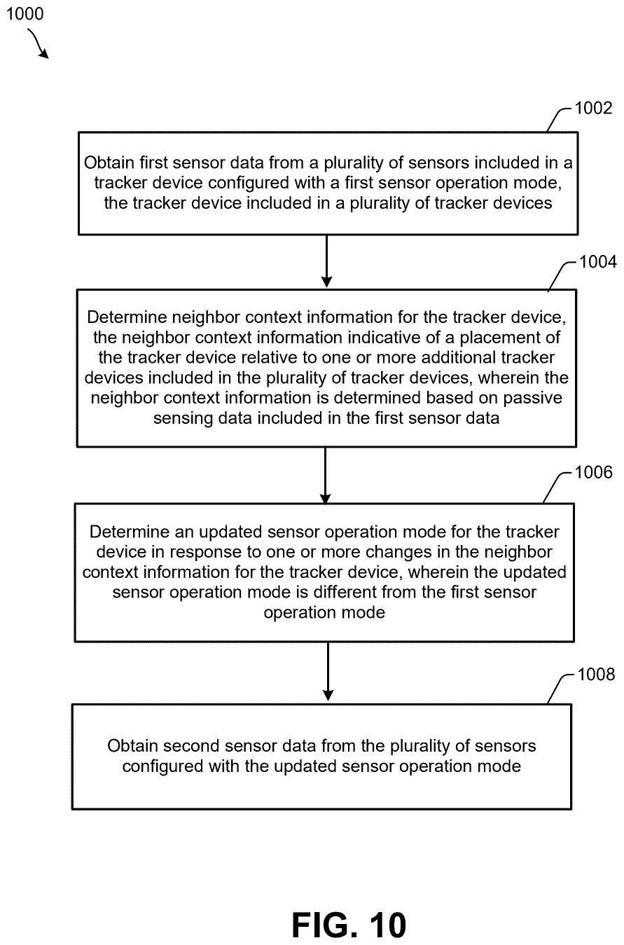

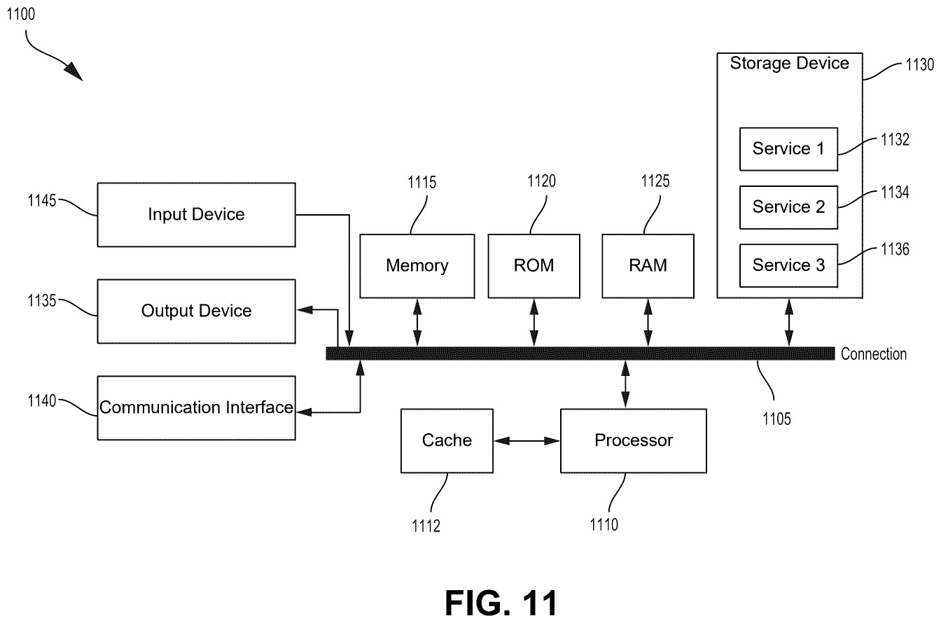

FIG. 10 is a flowchart diagram illustrating an example of a process 1000 for sensing and device tracking. In some examples, the process 1000 can be performed by a computing device or apparatus or a component or system (e.g., one or more chipsets, one or more processors such as one or more CPUs, DSPs, NPUs, NSPs, microcontrollers, ASICS, FPGAs, programmable logic devices, discrete gates or transistor logic components, discrete hardware components, etc., any combination thereof, and/or other component or system) of the computing device or apparatus. In some aspects, the process 1000 can be performed by a tracker device, such as any of the tracker devices of FIGS. 1-9. The operations of the process 1000 may be implemented as software components that are executed and run on one or more processors (e.g., processor 1110 of FIG. 11 or other processor(s)).

At block 1002, the computing device (or component thereof) can obtain first sensor data from a plurality of sensors included in a tracker device configured with a first sensor operation mode, the tracker device included in a plurality of tracker devices. For example, the tracker device may be the same as or similar to the RFID tag 250 of FIG. 2, the tracker device 310 of FIG. 3A, the tracker device 360 of FIG. 3B, the tracker device(s) 702a and/or 702b of FIG. 7A, the tracker device(s) 732a and/or 732b of FIG. 7B, the tracker device(s) 752a and/or 752b of FIG. 7C, the tracker device(s) 802a and/or 802b of FIG. 8A, the tracker device(s) 852a and/or 852b of FIG. 8B, the tracker device(s) B1, B2, and/or B3 of FIG. 9, etc. In some examples, the tracker device comprises a smart envelope tracker device or a smart label tracker device.

In some cases, sensor data obtained by the tracker device can be associated with a virtual group corresponding to the plurality of tracker devices. The association can be based on the neighbor context information determined for the tracker device. In some examples, the sensor data obtained by the tracker device and/or the first sensor data and/or the second sensor data can be the same as or similar to the sensor data 322 of FIG. 3A, the sensor data 372 of FIG. 3B, etc. In some cases, the first sensor operation mode and/or the updated sensor operation mode of the tracker device can correspond to a configuration of the sensor attribute configuration 326 of FIG. 3A and/or 376 of FIG. 3B. In some examples, the first sensor operation mode and/or the updated sensor operation mode of the tracker device can correspond to one or more of the sensor configuration parameters of FIGS. 7A-9 (e.g., the sensor ODR, the sensor range, the sensor power mode, etc.).

In some cases, the virtual group is associated with respective virtual group sensor data for each time instance of a plurality of time instances. In some cases, the respective virtual group sensor data for each time instance corresponds to sensor data obtained by the tracker device or an additional tracker device of the virtual group. The first sensor data can include respective passive sensing data obtained from each sensor of the plurality of sensors included in the tracker device. For example, the sensor data and/or the first sensor data and/or the second sensor data can comprise respective sensing data (e.g., passive sensing data, active sensing data, or combinations thereof) obtained from the IMU and/or ALS of the tracker device 310 of FIG. 3A, and/or can comprise respective sensing data (e.g., passive sensing data, active sensing data, or combinations thereof) obtained from one or more of the IMU, the magnetic sensor, the temperature sensor, the humidity sensor, the pressure sensor, the ALS sensor, the proximity sensor, and/or the time of flight sensor of the tracker device 360 of FIG. 3B, etc. In some cases, the first sensor data includes respective active sensing data obtained from one or more additional sensors included in the tracker device. In some examples, the first sensor data comprises passive sensing data obtained from one or more sensors of the plurality of sensors included in the tracker device.

At block 1004, the computing device (or component thereof) can determine neighbor context information for the tracker device, the neighbor context information indicative of a placement of the tracker device relative to one or more additional tracker devices included in the plurality of tracker devices, wherein the neighbor context information is determined based on passive sensing data included in the first sensor data.

For example, the neighbor context information can be determined using the ACD engine 330 of FIG. 3A and/or the ACD engine 380 of FIG. 3B. In some examples, the neighbor context information can be determined using the neighbor context detection 332 of FIG. 3A and/or the neighbor context detection 382 of FIG. 3B. In some cases, the neighbor context information can be the same as or similar to one or more portions of the neighbor context information of the examples of FIGS. 7A-9.

In some cases, the neighbor context information for the tracker device is determined without performing wireless communications by the tracker device. For example, the neighbor context information can be determined locally by the tracker device (e.g., by a processor of the tracker device, and without performing wireless communications by the tracker device), for example based on using the neighbor context detection 332 and/or the ACD engine 330 of FIG. 3A, and/or based on using the neighbor context detection 382 and/or the ACD engine 380 of FIG. 3B, etc.

In some cases, the neighbor context information for the tracker device is determined without wireless communication between the tracker device and each respective additional tracker device of the one or more additional tracker devices. For example, the neighbor context information can be determined without wired or wireless communications between the tracker device and any of the one or more additional tracker devices. In some cases, the one or more additional tracker devices are neighboring tracker devices nearby to the tracker device. In some examples, the one or more additional tracker devices are neighboring tracker devices within a threshold distance from the tracker device. For example, the one or more additional tracker devices can be neighboring tracker devices based on a distance determined by a portion of the sensor data 322, 372 of FIGS. 3A, 3B being determined to be within a threshold distance from the tracker device 310, 360 by the neighbor context detection 332, 382 (respectively).

In some examples, the threshold distance can correspond to a passive sensing range of one or more proximity sensors included in the plurality of sensors of the tracker device. For example, the threshold distance can correspond to a passive sensing range of an ALS or proximity sensor included in the tracker device 310 of FIG. 3A, the tracker device 360 of FIG. 3B, etc. In some examples, the threshold distance corresponds to a passive sensing range of one or more ambient light sensors included in the plurality of sensors of the tracker device.

In some cases, the tracker device may be associated with a virtual group comprising the tracker device and the one or more additional tracker devices. The virtual group can be formed from the plurality of tracker devices based on relative proximity information between respective tracker devices of the plurality of tracker devices. In some cases, the relative proximity information can be determined using the passive sensing data. In some examples, the virtual group can be formed from the plurality of tracker devices based on respective motion context information corresponding to each tracker device included in the virtual group. For example, the respective motion context information can be determined using the motion context detection 336 of FIG. 3A, the motion context detection 384 of FIG. 3B, the ACD state machine 400 of FIG. 4, the ACD state machine 500 of FIG. 5, etc. In some cases, information indicative of inclusion in the virtual group is not signaled to tracker devices included in the virtual group.

At block 1006, the computing device (or component thereof) can determine an updated sensor operation mode for the tracker device in response to one or more changes in the neighbor context information for the tracker device, wherein the updated sensor operation mode is different from the first sensor operation mode. For example, the one or more changes in the neighbor context information for the tracker device can be determined based on the neighbor context detection 332 of FIG. 3A and/or the neighbor context detection 382 of FIG. 3B. In some cases, the updated sensor operation mode can be determined by the sensor attribute reconfiguration 338 of FIG. 3A and/or the sensor attribute reconfiguration 387 of FIG. 3B.

In some cases, the tracker device may be configured to store state history information corresponding to the neighbor context information for the tracker device. For example, the state history information can include or comprise state history change information corresponding to the one or more changes in the neighbor context information for the tracker device, and the updated sensor operation mode can be determined based on or using the state history information.

In some cases, the updated sensor operation mode causes the tracker device to stop collection of respective sensor information from one or more sensors included in the plurality of sensors. The updated sensor operation mode to stop collection of respective sensor information can be determined in response to a change in the neighbor context information indicative of a placement of the one or more additional tracker devices on top of the tracker device. In some cases, the updated sensor operation mode corresponds to a reduction in a sensor data collection frequency by the tracker device.

In some examples, the updated sensor operation mode causes the tracker device to begin collection of respective sensor information from one or more additional sensors of the tracker device, where the one or more additional sensors are not included in the plurality of sensors. The updated sensor operation mode to begin collection of respective sensor information can be determined in response to a change in the neighbor context information indicative of a removal of the one or more additional tracker devices from a placement on top of the tracker device. In some examples, the updated sensor operation mode can correspond to an increase in a sensor data collection frequency by the tracker device.

In some cases, the updated sensor operation mode can correspond to an updated power saving configuration for the plurality of sensors included in the tracker. For example, the updated power saving configuration can be different from a first power saving configuration corresponding to the first sensor operation mode. The updated power saving configuration can be implemented using the sensor attribute reconfiguration 338 of the ACD engine 330 of FIG. 3A, and/or the sensor attribute reconfiguration 387 of the ACD engine 380 of FIG. 3B, etc.

In some examples, the updated power saving configuration comprises a low power configuration or an ultra-low power configuration, and the first power saving configuration comprises a high power configuration or a normal power configuration. In some cases, the updated power saving configuration comprises a high power configuration or a normal power configuration, and the first power saving configuration comprises a low power configuration or an ultra-low power configuration.

In some examples, the updated sensor operation mode corresponds to a different sensor data collection configuration than the first sensor operation mode. For example, the different sensor data collection configuration may correspond to one or more of an increase or decrease of a dynamic range configured for a sensor of the plurality of sensors, and/or an increase or decrease of an output data rate (ODR) configured for a sensor of the plurality of sensors. In some cases, the updated sensor operation mode corresponds to a different sensor data collection configuration than the first sensor operation mode, the different sensor data collection configuration corresponding to one or more of an increase or decrease of a sampling rate configured for a sensor of the plurality of sensors, or an increase or decrease of a configured complexity of a sensor of the plurality of sensors. In some cases, the increase of the configured complexity can be based on enabling one or more internal filters of the sensor, and the decrease of the configured complexity can be based on disabling one or more internal filters of the sensor.

At block 1008, the computing device (or component thereof) can obtain second sensor data from the plurality of sensors configured with the updated sensor operation mode. For example, the second sensor data can be obtained from the plurality of sensors, based on configuring the tracker device with the updated sensor operation mode, and subsequently using the plurality of sensors configured with the updated sensor operation mode to obtain the second sensor data. For example, the second sensor data obtained based on configuring the tracker device with the updated sensor operation mode can correspond to one of the changes in the sensor driving context for a respective one of the tracker devices illustrated in the examples of FIGS. 7A-9.

In some cases, the computing device (or component thereof) can be configured to determine, based on analyzing at least a portion of the first sensor data, device context information corresponding to a state of the tracker device. For example, the device context information can be determined using the ACD engine 330 of FIG. 3A and/or the ACD engine 380 of FIG. 3B. In some cases, the device context information can be determined at least in part based on the environment context detection 386 of FIG. 3B.

In some cases, the computing device (or component thereof) can be configured to determine, based on analyzing at least a portion of the first sensor data, motion context information corresponding to one or more movements of the tracker device. For example, the motion context can be determined based on the motion context detection 336 of FIG. 3A and/or the motion context detection 384 of FIG. 3B. In some cases, the computing device (or component thereof) can be configured to determine the neighbor context information and the one or more changes in the neighbor context information based on using an adaptive context detection (ACD) implemented by the first tracker device. For example, the ACD implemented by the first tracker device can correspond to and/or can be the same as or similar to one or more of the ACD engine 330 of FIG. 3A, the ACD engine 380 of FIG. 3B, etc. In some cases, the ACD implemented by the first tracker device can correspond to the ACD state engine 400 of FIG. 4 and/or the ACD state engine 500 of FIG. 5, etc. In some cases, each tracker device of the plurality of tracker devices can be associated with a respective ACD configured to determine a respective neighbor context information for each tracker device.

The network entity, network device, and/or the tracker device may include various components, such as one or more input devices, one or more output devices, one or more processors, one or more microprocessors, one or more microcomputers, one or more cameras, one or more sensors, one or more receivers, transmitters, and/or transceivers, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of a device configured to perform the process 1000 of FIG. 10 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 1000 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1000 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 11 is a block diagram illustrating an example of a computing system 1100, which may be employed by the disclosed systems and techniques. In particular, FIG. 11 illustrates an example of computing system 1100, which can be, for example, any computing device making up internal computing system, a remote computing system, a camera, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some aspects, computing system 1100 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1100 includes at least one processing unit (CPU or processor) 1110 and connection 1105 that communicatively couples various system components including system memory 1115, such as read-only memory (ROM) 1120 and random-access memory (RAM) 1125 to processor 1110. Computing system 1100 can include a cache 1112 of high-speed memory connected directly with, in close proximity to, or integrated as part of processor 1110.

Processor 1110 can include any general-purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms. In some instances, multimodal systems can enable a user to provide multiple types of input/output to communicate with computing system 1100.

Computing system 1100 can include communications interface 1140, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1140 may also include one or more range sensors (e.g., LIDAR sensors, laser range finders, RF radars, ultrasonic sensors, and infrared (IR) sensors) configured to collect data and provide measurements to processor 1110, whereby processor 1110 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc., that when the code that defines such software is executed by the processor 1110, it causes the system to perform a function. In some aspects, a hardware service that performs a particular function can include the software component stored in a computer-readable medium in connection with the necessary hardware components, such as processor 1110, connection 1105, output device 1135, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random-access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. A method comprising: obtaining first sensor data from a plurality of sensors included in a tracker device configured with a first sensor operation mode, the tracker device included in a plurality of tracker devices; determining neighbor context information for the tracker device, the neighbor context information indicative of a placement of the tracker device relative to one or more additional tracker devices included in the plurality of tracker devices, wherein the neighbor context information is determined based on passive sensing data included in the first sensor data; determining an updated sensor operation mode for the tracker device in response to one or more changes in the neighbor context information for the tracker device, wherein the updated sensor operation mode is different from the first sensor operation mode; and obtaining second sensor data from the plurality of sensors configured with the updated sensor operation mode.

Aspect 2. The method of Aspect 1, wherein sensor data obtained by the tracker device is associated with a virtual group corresponding to the plurality of tracker devices, the association based on the neighbor context information.

Aspect 3. The method of Aspect 2, wherein: the virtual group is associated with respective virtual group sensor data for each time instance of a plurality of time instances; and the respective virtual group sensor data for each time instance corresponds to sensor data obtained by one or more of the tracker device or an additional tracker device of the virtual group.

Aspect 4. The method of any of Aspects 1 to 3, wherein: the first sensor data includes respective passive sensing data obtained from each sensor of the plurality of sensors included in the tracker device.

Aspect 5. The method of any of Aspects 1 to 4, wherein the first sensor data includes passive sensing data obtained from one or more sensors of the plurality of sensors, and further includes active sensing data obtained from one or more additional sensors of the plurality of sensors.

Aspect 6. The method of any of Aspects 1 to 5, wherein: the first sensor data comprises passive sensing data obtained from one or more sensors of the plurality of sensors included in the tracker device.

Aspect 7. The method of any of Aspects 1 to 6, wherein the neighbor context information for the tracker device is determined without performing wireless communications by the tracker device.

Aspect 8. The method of any of Aspects 1 to 7, wherein the neighbor context information for the tracker device is determined without wireless communication between the tracker device and each respective additional tracker device of the one or more additional tracker devices.

Aspect 9. The method of any of Aspects 1 to 8, wherein the one or more additional tracker devices are neighboring tracker devices nearby to the tracker device.

Aspect 10. The method of any of Aspects 1 to 9, wherein the tracker device is associated with a virtual group comprising the tracker device and the one or more additional tracker devices.

Aspect 11. The method of Aspect 10, wherein the virtual group is formed from the plurality of tracker devices based on relative proximity information between respective tracker devices of the plurality of tracker devices, and wherein the relative proximity information is determined using the passive sensing data.

Aspect 12. The method of any of Aspects 10 to 11, wherein the virtual group is formed from the plurality of tracker devices based on respective motion context information corresponding to each tracker device included in the virtual group.

Aspect 13. The method of any of Aspects 10 to 12, wherein information indicative of inclusion in the virtual group is not signaled to tracker devices included in the virtual group.

Aspect 14. The method of any of Aspects 1 to 13, wherein the one or more additional tracker devices are neighboring tracker devices within a threshold distance from the tracker device.

Aspect 15. The method of Aspect 14, wherein the threshold distance corresponds to a passive sensing range of one or more proximity sensors included in the plurality of sensors of the tracker device.

Aspect 16. The method of any of Aspects 14 to 15, wherein the threshold distance corresponds to a passive sensing range of one or more ambient light sensors included in the plurality of sensors of the tracker device.

Aspect 17. The method of any of Aspects 1 to 16, wherein the updated sensor operation mode causes the tracker device to stop collection of respective sensor information from one or more sensors included in the plurality of sensors.

Aspect 18. The method of Aspect 17, wherein the updated sensor operation mode to stop collection of respective sensor information is determined in response to a change in the neighbor context information indicative of a placement of the one or more additional tracker devices on the tracker device.

Aspect 19. The method of any of Aspects 17 to 18, wherein the updated sensor operation mode corresponds to a reduction in a sensor data collection frequency by the tracker device.

Aspect 20. The method of any of Aspects 1 to 19, wherein the updated sensor operation mode causes the tracker device to begin collection of respective sensor information from one or more additional sensors of the tracker device, wherein the one or more additional sensors are not included in the plurality of sensors.

Aspect 21. The method of Aspect 20, wherein the updated sensor operation mode to begin collection of respective sensor information is determined in response to a change in the neighbor context information indicative of a removal of the one or more additional tracker devices from a placement on the tracker device.

Aspect 22. The method of any of Aspects 20 to 21, wherein the updated sensor operation mode corresponds to an increase in a sensor data collection frequency by the tracker device.

Aspect 23. The method of any of Aspects 1 to 22, wherein: the updated sensor operation mode corresponds to an updated power saving configuration for the plurality of sensors included in the tracker; and the updated power saving configuration is different from a first power saving configuration corresponding to the first sensor operation mode.

Aspect 24. The method of Aspect 23, wherein: the updated power saving configuration comprises a low power configuration or an ultra-low power configuration; and the first power saving configuration comprises a high power configuration or a normal power configuration.

Aspect 25. The method of any of Aspects 23 to 24, wherein: the updated power saving configuration comprises a high power configuration or a normal power configuration; and the first power saving configuration comprises a low power configuration or an ultra-low power configuration.

Aspect 26. The method of any of Aspects 1 to 25, wherein the updated sensor operation mode corresponds to a different sensor data collection configuration than the first sensor operation mode, the different sensor data collection configuration corresponding to one or more of: an increase or decrease of a dynamic range configured for a sensor of the plurality of sensors; or an increase or decrease of an output data rate (ODR) configured for a sensor of the plurality of sensors.

Aspect 27. The method of any of Aspects 1 to 26, wherein the updated sensor operation mode corresponds to a different sensor data collection configuration than the first sensor operation mode, the different sensor data collection configuration corresponding to one or more of: an increase or decrease of a sampling rate configured for a sensor of the plurality of sensors; or an increase or decrease of a configured complexity of a sensor of the plurality of sensors, wherein the increase of the configured complexity is based on enabling one or more internal filters of the sensor, and wherein the decrease of the configured complexity is based on disabling one or more internal filters of the sensor.

Aspect 28. The method of any of Aspects 1 to 27, wherein the tracker device is configured to store state history information corresponding to the neighbor context information for the tracker device.

Aspect 29. The method of Aspect 28, wherein the state history information comprises state history change information corresponding to the one or more changes in the neighbor context information for the tracker device.

Aspect 30. The method of any of Aspects 1 to 29, further comprising determining, based on analyzing at least a portion of the first sensor data, device context information corresponding to a state of the tracker device.

Aspect 31. The method of any of Aspects 1 to 30, further comprising determining, based on analyzing at least a portion of the first sensor data, motion context information corresponding to one or more movements of the tracker device.

Aspect 32. The method of any of Aspects 1 to 31, wherein: determining the neighbor context information and the one or more changes in the neighbor context information is based on using an adaptive context detection (ACD) implemented by the first tracker device.

Aspect 33. The method of Aspect 32, wherein each tracker device of the plurality of tracker devices is associated with a respective ACD configured to determine a respective neighbor context information for each tracker device.

Aspect 34. The method of any of Aspects 1 to 34, wherein the tracker device comprises a smart envelope tracker device or a smart label tracker device.

Aspect 35. An apparatus of a tracker device, the tracker device comprising: at least one memory; and at least one processor coupled to the at least one memory and configured to: obtain first sensor data from a plurality of sensors included in the tracker device configured with a first sensor operation mode, the tracker device included in a plurality of tracker devices; determine neighbor context information for the tracker device, the neighbor context information indicative of a placement of the tracker device relative to one or more additional tracker devices included in the plurality of tracker devices, wherein the neighbor context information is determined based on passive sensing data included in the first sensor data; determine an updated sensor operation mode for the tracker device in response to one or more changes in the neighbor context information for the tracker device, wherein the updated sensor operation mode is different from the first sensor operation mode; and obtain second sensor data from the plurality of sensors configured with the updated sensor operation mode.

Aspect 36. The apparatus of Aspect 35, wherein sensor data obtained by the tracker device is associated with a virtual group corresponding to the plurality of tracker devices, the association based on the neighbor context information.

Aspect 37. The apparatus of Aspect 36, wherein: the virtual group is associated with respective virtual group sensor data for each time instance of a plurality of time instances; and the respective virtual group sensor data for each time instance corresponds to sensor data obtained by one or more of the tracker device or an additional tracker device of the virtual group.

Aspect 38. The apparatus of any of Aspects 35 to 37, wherein: the first sensor data includes respective passive sensing data obtained from each sensor of the plurality of sensors included in the tracker device.

Aspect 39. The apparatus of any of Aspect 35 to 38, wherein the first sensor data includes passive sensing data obtained from one or more sensors of the plurality of sensors, and further includes active sensing data obtained from one or more additional sensors of the plurality of sensors.

Aspect 40. The apparatus of any of Aspects 35 to 39, wherein: the first sensor data comprises passive sensing data obtained from one or more sensors of the plurality of sensors included in the tracker device.

Aspect 41. The apparatus of any of Aspects 35 to 40, wherein the at least one processor is configured to determine the neighbor context information for the tracker device without performing wireless communications by the tracker device.

Aspect 42. The apparatus of any of Aspects 35 to 41, wherein the at least one processor is configured to determine the neighbor context information for the tracker device without wireless communication between the tracker device and each respective additional tracker device of the one or more additional tracker devices.

Aspect 43. The apparatus of any of Aspects 35 to 42, wherein the one or more additional tracker devices are neighboring tracker devices nearby to the tracker device.

Aspect 44. The apparatus of any of Aspects 35 to 43, wherein the tracker device is associated with a virtual group comprising the tracker device and the one or more additional tracker devices.

Aspect 45. The apparatus of Aspect 44, wherein the virtual group is formed from the plurality of tracker devices based on relative proximity information between respective tracker devices of the plurality of tracker devices, and wherein the relative proximity information is determined using the passive sensing data.

Aspect 46. The apparatus of any of Aspects 44 to 45, wherein the virtual group is formed from the plurality of tracker devices based on respective motion context information corresponding to each tracker device included in the virtual group.

Aspect 47. The apparatus of any of Aspects 44 to 46, wherein information indicative of inclusion in the virtual group is not signaled to tracker devices included in the virtual group.

Aspect 48. The apparatus of any of Aspects 35 to 47, wherein the one or more additional tracker devices are neighboring tracker devices within a threshold distance from the tracker device.

Aspect 49. The apparatus of Aspect 48, wherein the threshold distance corresponds to a passive sensing range of one or more proximity sensors included in the plurality of sensors of the tracker device.

Aspect 50. The apparatus of any of Aspects 48 to 49, wherein the threshold distance corresponds to a passive sensing range of one or more ambient light sensors included in the plurality of sensors of the tracker device.

Aspect 51. The apparatus of any of Aspects 35 to 50, wherein the updated sensor operation mode causes the tracker device to stop collection of respective sensor information from one or more sensors included in the plurality of sensors.

Aspect 52. The apparatus of Aspect 51, wherein the at least one processor is configured to determine the updated sensor operation mode to stop collection of respective sensor information in response to a change in the neighbor context information indicative of a placement of the one or more additional tracker devices on the tracker device.

Aspect 53. The apparatus of any of Aspects 51 to 52, wherein the updated sensor operation mode corresponds to a reduction in a sensor data collection frequency by the tracker device.

Aspect 54. The apparatus of any of Aspects 35 to 53, wherein the updated sensor operation mode causes the tracker device to begin collection of respective sensor information from one or more additional sensors of the tracker device, wherein the one or more additional sensors are not included in the plurality of sensors.

Aspect 55. The apparatus of Aspect 54, wherein the at least one processor is configured to determine the updated sensor operation mode to begin collection of respective sensor information in response to a change in the neighbor context information indicative of a removal of the one or more additional tracker devices from a placement on the tracker device.

Aspect 56. The apparatus of any of Aspects 54 to 55, wherein the updated sensor operation mode corresponds to an increase in a sensor data collection frequency by the tracker device.

Aspect 57. The apparatus of any of Aspects 35 to 56, wherein: the updated sensor operation mode corresponds to an updated power saving configuration for the plurality of sensors included in the tracker; and the updated power saving configuration is different from a first power saving configuration corresponding to the first sensor operation mode.

Aspect 58. The apparatus of Aspect 57, wherein: the updated power saving configuration comprises a low power configuration or an ultra-low power configuration; and the first power saving configuration comprises a high power configuration or a normal power configuration.

Aspect 59. The apparatus of any of Aspects 57 to 58, wherein: the updated power saving configuration comprises a high power configuration or a normal power configuration; and the first power saving configuration comprises a low power configuration or an ultra-low power configuration.

Aspect 60. The apparatus of any of Aspects 35 to 59, wherein the updated sensor operation mode corresponds to a different sensor data collection configuration than the first sensor operation mode, the different sensor data collection configuration corresponding to one or more of: an increase or decrease of a dynamic range configured for a sensor of the plurality of sensors; or an increase or decrease of an output data rate (ODR) configured for a sensor of the plurality of sensors.

Aspect 61. The apparatus of any of Aspects 35 to 60, wherein the updated sensor operation mode corresponds to a different sensor data collection configuration than the first sensor operation mode, the different sensor data collection configuration corresponding to one or more of: an increase or decrease of a sampling rate configured for a sensor of the plurality of sensors; or an increase or decrease of a configured complexity of a sensor of the plurality of sensors, wherein the increase of the configured complexity is based on enabling one or more internal filters of the sensor, and wherein the decrease of the configured complexity is based on disabling one or more internal filters of the sensor.

Aspect 62. The apparatus of any of Aspects 35 to 61, wherein the tracker device is configured to store state history information corresponding to the neighbor context information for the tracker device.

Aspect 63. The apparatus of Aspect 62, wherein the state history information comprises state history change information corresponding to the one or more changes in the neighbor context information for the tracker device.

Aspect 64. The apparatus of any of Aspects 35 to 63, wherein the at least one processor is further configured to determine, based on analyzing at least a portion of the first sensor data, device context information corresponding to a state of the tracker device.

Aspect 65. The apparatus of any of Aspects 35 to 64, wherein the at least one processor is further configured to determine, based on analyzing at least a portion of the first sensor data, motion context information corresponding to one or more movements of the tracker device.

Aspect 66. The apparatus of any of Aspects 35 to 65, wherein, to determine the neighbor context information and the one or more changes in the neighbor context information, the at least one processor is configured to use an adaptive context detection (ACD) implemented by the first tracker device.

Aspect 67. The apparatus of Aspect 66, wherein each tracker device of the plurality of tracker devices is associated with a respective ACD configured to determine a respective neighbor context information for each tracker device.

Aspect 68. The apparatus of any of Aspects 35 to 67, wherein the tracker device comprises a smart envelope tracker device or a smart label tracker device.

Aspect 69. A non-transitory computer-readable medium storing instructions thereon which are executable by one or more processors to cause the one or more processors to perform operations comprising: obtaining first sensor data from a plurality of sensors included in a tracker device configured with a first sensor operation mode, the tracker device included in a plurality of tracker devices; determining neighbor context information for the tracker device, the neighbor context information indicative of a placement of the tracker device relative to one or more additional tracker devices included in the plurality of tracker devices, wherein the neighbor context information is determined based on passive sensing data included in the first sensor data; determining an updated sensor operation mode for the tracker device in response to one or more changes in the neighbor context information for the tracker device, wherein the updated sensor operation mode is different from the first sensor operation mode; and obtaining second sensor data from the plurality of sensors configured with the updated sensor operation mode.

Aspect 70. A method for wireless communication, comprising performing operations according to any of Aspects 35 to 68.

Aspect 71. A non-transitory computer-readable storage medium comprising instructions stored thereon which, when executed by at least one processor, causes the at least one processor to perform operations according to any of Aspects 1 to 34.

Aspect 72. A non-transitory computer-readable storage medium comprising instructions stored thereon which, when executed by at least one processor, causes the at least one processor to perform operations according to any of Aspects 35 to 68.

Aspect 73. An apparatus for wireless communication comprising one or more means for performing operations according to any of Aspects 1 to 34.

Aspect 74. An apparatus for wireless communication comprising one or more means for performing operations according to any of Aspects 35 to 68.

What is claimed is:

1. A method comprising:
obtaining first sensor data from a plurality of sensors included in a tracker device configured with a first sensor operation mode, the tracker device included in a plurality of tracker devices;
determining neighbor context information for the tracker device, the neighbor context information indicative of a placement of the tracker device relative to one or more additional tracker devices included in the plurality of tracker devices, wherein the neighbor context information is determined based on passive sensing data included in the first sensor data;
determining an updated sensor operation mode for the tracker device in response to one or more changes in the neighbor context information for the tracker device, wherein the updated sensor operation mode is different from the first sensor operation mode; and
obtaining second sensor data from the plurality of sensors configured with the updated sensor operation mode.

2. The method of claim 1, wherein sensor data obtained by the tracker device is associated with a virtual group corresponding to the plurality of tracker devices, the association based on the neighbor context information.

3. The method of claim 2, wherein:
the virtual group is associated with respective virtual group sensor data for each time instance of a plurality of time instances; and
the respective virtual group sensor data for each time instance corresponds to sensor data obtained by one or more of the tracker device or an additional tracker device of the virtual group.

4. The method of claim 1, wherein:
the first sensor data includes respective passive sensing data obtained from each sensor of the plurality of sensors included in the tracker device.

5. The method of claim 1, wherein the first sensor data includes passive sensing data obtained from one or more sensors of the plurality of sensors, and further includes active sensing data obtained from one or more additional sensors of the plurality of sensors.

6. The method of claim 1, wherein the neighbor context information for the tracker device is determined without wireless communication between the tracker device and each respective additional tracker device of the one or more additional tracker devices.

7. The method of claim 1, wherein the one or more additional tracker devices are neighboring tracker devices within a threshold distance from the tracker device.

8. The method of claim 7, wherein the threshold distance corresponds to a passive sensing range of one or more proximity sensors included in the plurality of sensors of the tracker device.

9. The method of claim 1, wherein the updated sensor operation mode causes the tracker device to: stop collection of respective sensor information from one or more sensors included in the plurality of sensors, or reduce a sensor data collection frequency for one or more sensors included in the plurality of sensors.

10. The method of claim 9, wherein the updated sensor operation mode to stop collection of respective sensor information is determined in response to a change in the neighbor context information indicative of a placement of the one or more additional tracker devices on the tracker device.

11. The method of claim 1, wherein the updated sensor operation mode causes the tracker device to: begin collection of respective sensor information from one or more additional sensors of the tracker device, wherein the one or more additional sensors are not included in the plurality of sensors, or to increase a sensor data collection frequency for one or more sensors included in the plurality of sensors.

12. The method of claim 11, wherein the updated sensor operation mode to begin collection of respective sensor information is determined in response to a change in the neighbor context information indicative of a removal of the one or more additional tracker devices from a placement on the tracker device.

13. The method of claim 1, wherein:
the updated sensor operation mode corresponds to an updated power saving configuration for the plurality of sensors included in the tracker; and
the updated power saving configuration is different from a first power saving configuration corresponding to the first sensor operation mode.

14. The method of claim 1, wherein the updated sensor operation mode corresponds to a different sensor data collection configuration than the first sensor operation mode, the different sensor data collection configuration corresponding to one or more of:
an increase or decrease of a dynamic range configured for a sensor of the plurality of sensors; or
an increase or decrease of an output data rate (ODR) configured for a sensor of the plurality of sensors.

15. The method of claim 1, wherein the updated sensor operation mode corresponds to a different sensor data collection configuration than the first sensor operation mode, the different sensor data collection configuration corresponding to one or more of:
an increase or decrease of a sampling rate configured for a sensor of the plurality of sensors; or
an increase or decrease of a configured complexity of a sensor of the plurality of sensors, wherein the increase of the configured complexity is based on enabling one or more internal filters of the sensor, and wherein the decrease of the configured complexity is based on disabling one or more internal filters of the sensor.

16. The method of claim 1, wherein the tracker device is configured to store state history information corresponding to the neighbor context information for the tracker device.

17. The method of claim 16, wherein the state history information comprises state history change information corresponding to the one or more changes in the neighbor context information for the tracker device.

18. The method of claim 1, further comprising determining, based on analyzing at least a portion of the first sensor data, device context information corresponding to a state of the tracker device.

19. The method of claim 1, further comprising determining, based on analyzing at least a portion of the first sensor data, motion context information corresponding to one or more movements of the tracker device.

20. The method of claim 1, wherein the tracker device comprises a smart envelope tracker device or a smart label tracker device.

21. An apparatus of a tracker device, the tracker device comprising:
at least one memory; and
at least one processor coupled to the at least one memory and configured to:
obtain first sensor data from a plurality of sensors included in the tracker device configured with a first sensor operation mode, the tracker device included in a plurality of tracker devices;
determine neighbor context information for the tracker device, the neighbor context information indicative of a placement of the tracker device relative to one or more additional tracker devices included in the plurality of tracker devices, wherein the neighbor context information is determined based on passive sensing data included in the first sensor data;
determine an updated sensor operation mode for the tracker device in response to one or more changes in the neighbor context information for the tracker device, wherein the updated sensor operation mode is different from the first sensor operation mode; and
obtain second sensor data from the plurality of sensors configured with the updated sensor operation mode.

22. The apparatus of claim 21, wherein sensor data obtained by the tracker device is associated with a virtual group corresponding to the plurality of tracker devices, the association based on the neighbor context information.

23. The apparatus of claim 22, wherein:
the virtual group is associated with respective virtual group sensor data for each time instance of a plurality of time instances; and
the respective virtual group sensor data for each time instance corresponds to sensor data obtained by one or more of the tracker device or an additional tracker device of the virtual group.

24. The apparatus of claim 21, wherein:
the first sensor data includes respective passive sensing data obtained from each sensor of the plurality of sensors included in the tracker device.

25. The apparatus of claim 21, wherein the first sensor data includes passive sensing data obtained from one or more sensors of the plurality of sensors, and further includes active sensing data obtained from one or more additional sensors of the plurality of sensors.

26. The apparatus of claim 21, wherein the at least one processor is configured to determine the neighbor context information for the tracker device without wireless communication between the tracker device and each respective additional tracker device of the one or more additional tracker devices.

27. The apparatus of claim 21, wherein the one or more additional tracker devices are neighboring tracker devices within a threshold distance from the tracker device.

28. The apparatus of claim 27, wherein the threshold distance corresponds to a passive sensing range of one or more proximity sensors included in the plurality of sensors of the tracker device.

29. The apparatus of claim 21, wherein the updated sensor operation mode causes the tracker device to: stop collection of respective sensor information from one or more sensors included in the plurality of sensors, or reduce a sensor data collection frequency for one or more sensors included in the plurality of sensors.

30. A non-transitory computer-readable medium storing instructions thereon which are executable by one or more processors to cause the one or more processors to perform operations comprising:
obtaining first sensor data from a plurality of sensors included in a tracker device configured with a first sensor operation mode, the tracker device included in a plurality of tracker devices;
determining neighbor context information for the tracker device, the neighbor context information indicative of a placement of the tracker device relative to one or more additional tracker devices included in the plurality of tracker devices, wherein the neighbor context information is determined based on passive sensing data included in the first sensor data;
determining an updated sensor operation mode for the tracker device in response to one or more changes in the neighbor context information for the tracker device, wherein the updated sensor operation mode is different from the first sensor operation mode; and
obtaining second sensor data from the plurality of sensors configured with the updated sensor operation mode.
